(19) United States
(12) Patent Application Publication
(10) Pub. No.: US 2026/0371036 A1
(43) Pub. Date: Nov. 19, 2026

(54) CRYPTOGRAPHIC INFORMATION DELEGATION

(71) Applicant: Apple Inc., Cupertino, CA (US)

(72) Inventors: Siva Ganesh Movva, San Jose, CA (US); John T. Perry, Portland, OR (US)

(73) Assignee: Apple Inc., Cupertino, CA (US)

(21) Appl. No.: 19/680,649

(22) Filed: May 18, 2026

Related U.S. Application Data
(60) Provisional application No. 63/808,458, filed on May 19, 2025.

(51) Int. Cl. H04W 4/029; G08B 3/10

(52) U.S. Cl. CPC H04W 4/029; G08B 3/1025

(57) ABSTRACT

Techniques may include receiving a network location identifier associated with a portable device. The techniques may include accessing a tracking identifier for the portable device using the network location identifier. The techniques may include initiating a local finding operation with the portable device. The local finding operation may include identifying the portable device by matching at least a portion of the tracking identifier to an advertising message that is received at the electronic user device from the portable device. The local finding operation may include establishing a communication link with the portable device. The local finding operation may include communicating with the portable device to perform the local finding operation via the communication link.

### CROSS-REFERENCES TO RELATED APPLICATIONS

This application claims the benefit of U.S. provisional Application No. 63/808,458, entitled “Cryptographic Information Delegation,” filed on May 19, 2025, the disclosure of which is incorporated by reference herein in its entirety for all purposes.

### BACKGROUND

It may be beneficial to delegate location monitoring and control of a device to a third party, for example, to help an airport employee locate a luggage tag or to enable activation lock transfer during device repair. However, sharing cryptographic information with a third party may enable unintended tracking and control of a device. Accordingly, improved delegation of cryptographic information to third parties is desirable.

BRIEF SUMMARY Techniques may include receiving a network location identifier associated with a portable device. The techniques may include accessing a tracking identifier for the portable device using the network location identifier. The techniques may include initiating a local finding operation with the portable device. The local finding operation may include identifying the portable device by matching at least a portion of the tracking identifier to an advertising message that is received at the electronic user device from the portable device. The local finding operation may include establishing a communication link with the portable device. The local finding operation may include communicating with the portable device to perform the local finding operation via the communication link.

The techniques may include receiving a request to authorize a transfer of an activation lock for an account of a location service from a first device to a second device. An activation locked state can be enabled on the first device. In addition, the techniques may include providing an approval notice that authorizes the request to transfer the activation lock. The approval notice can include authentication information for the account. The techniques may include receiving a confirmation notice that the transfer of the activation lock from the first device to the second device has been authorized.

The techniques may include providing a request to authorize a transfer of an activation lock for an account of a location service from a first device to a second device. An activation locked state can be enabled on the first device. In addition, the techniques may include receiving an approval notice that authorizes the request to transfer the activation lock. The approval notice can include authentication information for the account. The techniques may include enabling a transfer of the activation lock from the first device to the second device. The second device may be in an activation locked state after the transfer.

The techniques may be implemented as methods, systems, devices, and computer-readable instructions stored on non-transitory computer readable mediums. The device may include one or more processors and a memory coupled to the one or more processors. The memory can store instructions that cause the one or more processors to perform the techniques. The non-transitory computer readable medium can store instructions that when executed on one or more processors cause the one or more processors to perform operations to implement the techniques.

### BRIEF DESCRIPTION OF THE DRAWINGS

FIG. 1 is a system architecture for a location system according to various embodiments.

FIG. 2 is a simplified diagram of an architecture for sharing permission to perform a local finding operation to a third-party device according to various embodiments.

FIG. 3 is a flow chart of process for techniques to initiate a local finding operation according to various embodiments.

FIG. 4 is a flow chart of process for techniques to perform a local finding operation according to various embodiments.

FIG. 5 is a simplified diagram and a process for an activation lock transfer according to various embodiments.

FIG. 6 is a flow chart of a process for techniques to verify a request to authorize an activation lock transfer according to various embodiments.

FIG. 7 is a flow chart of process for techniques for requesting an authorization lock transfer according to various embodiments.

FIG. 8 is a block diagram of an example electronic device according to various embodiments.

FIG. 9 is a block diagram of components of a mobile device operable to perform passive beacon communication techniques according to various embodiments.

FIG. 10 is a block diagram of an example mobile device according to various embodiments.

### DETAILED DESCRIPTION

A crowd sourced location service can enable monitoring and control of a group of related devices using cryptographic information. Crowd sourced location monitoring is enabled using electronic devices that monitor for messages from tracked devices. The messages can be encrypted using public-key cryptography and an electronic device can use cryptographic information to recognize a message from a portable device that is related to the electronic device. If the electronic device does not recognize a message, the device can provide the message and a current location to the location service, and the service can use the cryptographic information to provide the portable device's location to an associated device. These encryption techniques can allow crowd sourced tracking without enabling an unrelated device to access location information.

In a first particular example, the crowd sourced location service's cryptographic information can be used to control a portable device. An electronic device may use cryptographic information to identify proximity messages from a portable device to locate and control the device. The electronic device can provide the cryptographic information to a third-party device, and the third-party device can use the information to identify proximity messages from the portable device. After recognizing the messages from the portable electronic device, the third-party device can communicate with the portable device to perform a local finding operation. For example, the third-party device can perform ranging with the portable device to locate the device. The local finding operation may include sending instructions to the portable device, and, for example, the third-party device may instruct the portable device to emit a sound.

In a second particular example, the portable device can enter an activation locked state in certain circumstances. For example, the portable device may enter an activation locked state when the device powers on or after a period of inactivity. The activation locked state may limit the functionality of the portable device until the cryptographic information is authenticated on the device. The authentication locked state can help to prevent device theft because an activation locked device has limited functionality without the cryptographic information. The activation locked state can be associated with an account of the crowd sourced location tracking service, and the activation locked state can be removed by authenticating the cryptographic information (e.g., authentication information) associated with the account on the locked device.

An electronic device may delegate authority to remove the activation locked state to a third-party device. For example, the electronic device's user may want to allow a technician to repair the portable device, and removing the activation lock can allow the technician to reboot the portable device. In addition, delegating the authority to remove the activation locked state can allow the third-party device to transfer the activation locked state from the portable device to a new portable device if the portable device needs to be replaced. Transferring the activation locked state can mean instructing the crowd sourced location service to associate the cryptographic information with the new device or instructing the service to generate new cryptographic information for the new device.

The electronic device can delegate authority to remove the activation locked state by authenticating a request from the third-party device. The third-party device can send a request to the electronic device and the electronic device can authenticate the request using the electronic device's cryptographic information. For example, the electronic device can sign a token using the cryptographic information and the token can be provided to the third-party device in a response to the request. The third-party device can provide the token to the portable device with an instruction to remove the activation locked state.

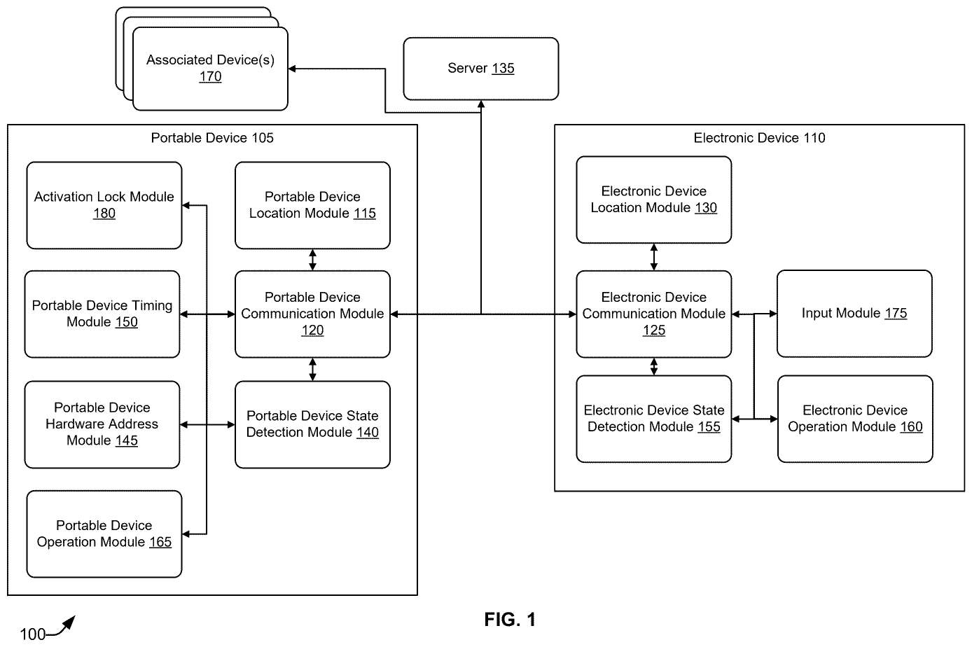

FIG. 1 is a system architecture 100 for a location service according to various embodiments. The portable device 105 can be any electronic device that is capable of wireless communication to an electronic device 110. For example, the portable device 105 can be a beacon device (e.g., a tag), a smartphone, a smartwatch, a tablet computer, a laptop computer, and headphones. The portable device 105 can be used to provide location information to the electronic device 110 that is in communication with the portable device 105. In some embodiments, portable device 105 may have a location module 115 that can determine the device's location (e.g., via GPS). The location module 115 can provide this information to electronic device 110 in the payload of a proximity message that is sent via a portable device communication module 120. In some embodiments, the portable device 105 may not have a location module 115, and the electronic device may determine the device's location after receiving a message from the portable device 105.

The electronic device 110 can receive the proximity message, with the portable device's location, at an electronic device communication module 125. The location of the portable device 105 can be extracted from the proximity message payload by the electronic device communication module 125, and the communication module 125 can forward the location, via a network connection, to a server 135 that stores location information corresponding to the portable device 105. The server 135 may provide the location to associated device(s) 170. The associated devices 170 and the portable device 105 can be associated with an account of a location service, and cryptographic information for the account may be authenticated on each of the associated device(s) 170 and the portable device 105. The location service can be a crowd sourced service for device monitoring. An electronic device that is associated with the location service can monitor for proximity messages from portable devices that are monitored by the service. The proximity messages can include cryptographic information that the location service can use to identify a specific portable device. An electronic device that is associated with a portable device can use the cryptographic information to recognize a message from a portable device, but the electronic device cannot identify a portable device that is not associated with the electronic device.

The proximity message received at the electronic device communications module 125 may not include location information, and the electronic device 110 can retrieve location information from the mobile device location module 130. This retrieved location information can be forwarded by the electronic device communication module 125 to the server 135. The message to the server 135 may include an anonymized identifier, such as a derived hardware identifier that is generated using cryptographic information, so that a mobile device that is paired with (e.g., associated with) the portable device 105 can retrieve the location information without the electronic device 110 knowing the paired device's location.

The location information for a message received from the portable device 105 may be forwarded by the electronic device 110 if the message is a far state message. A proximity message with a far state payload (e.g., a far state message) can be reported to the server 135, however, a message with a near state payload (e.g., a near state payload) may not be reported to the server. A near state proximity message indicates that the portable device 105 has determined that the device is near a paired device, and, in such circumstances, the location information may be reported from the portable device 105 to the paired electronic device in a proximity message (e.g., an advertising message) payload.

The portable device communication module 120 can transmit proximity messages with different payloads depending on whether the portable device 105 is in a near state or a far state. A portable device state detection module 140 can determine the portable device's state based on reply messages received at the portable device communication module 120 (e.g., whether a reply message received or not and whether it is from a paired mobile device). In some implementations, an electronic device only sends a reply message when it is paired to the portable device. In other implementations, the portable device can determine whether a reply message is from a paired electronic device.

Reply messages received at the portable device communication module 120 forwarded to the portable device state detection module 140. The portable device 105 can be a portable device, a mobile device, an electronic device, etc. The reply message can be used by the portable device state detection module 140 to determine if the portable device 105 is in a near state or a far state. For instance, a portable device may be in a near state for the duration of a time period that begins after a threshold number of reply messages are received from a paired mobile device. This time period can restart at each subsequent reply message above the threshold that is received during the time period (e.g., a 30:00-minute time period restarts as long as a reply message is received between 00:00 minutes and 29:59 minutes). The threshold can be 0 reply messages, 1 reply message, 2 replay messages, 3 reply messages, 4 reply messages, 5 reply messages, 10 reply messages, 20 reply messages, 30 reply messages, 40 reply messages, 50 reply messages, or 100 reply messages. In addition, or alternatively, a portable device may be in a far state if the device has not received a reply message by the conclusion of a time period that begins when the device transmits a threshold number of proximity message. The threshold can be 0 proximity messages, 1 proximity message, 2 replay messages, 3 proximity messages, 4 proximity messages, 5 proximity messages, 10 proximity messages, 20 proximity messages, 30 proximity messages, 40 proximity messages, 50 proximity messages, or 100 proximity messages.

The portable device communication module 120 can collect information from one or more modules to prepare a proximity message payload (e.g., an advertising message payload). The key derivation function (e.g., cryptographic information) used by the portable device hardware address module 145 can be associated with a protocol identifier, and the derived hardware address, with the protocol identifier, can be provided to the portable device communication module 120 by the portable device hardware address module 145. The derived hardware address may be provided in response to a request from the portable device communication module 120. The request may be triggered by a determination that portable device 105 is in a near state, and the portable device communication module 120 may reuse a derived hardware address from a previous proximity message when the portable device is in a far state. The portable device timing module 150 can provide timing information to the portable device communication module 120, and the current state for portable device 105 can be provided from the portable device state detection module 140 to the portable device communication module 120.

The portable device communication module 120 can prepare and transmit a proximity message to the electronic device communication module 125. The proximity message payload can depend on the information indicating the device state received from the portable device state detection module 140. For instance, the proximity message payload may include a state flag indicating whether the proximity message is in a near state or a far state. The proximity message may include cryptographic information such as a derived hardware address that the portable device communication module 120 requests from the portable device hardware address module 145. The derived hardware address can be requested after each near state proximity message, after a first threshold number of proximity messages have been transmitted, or after a first time period. The derived hardware address for far state proximity messages may not change and the portable device communication module may request a new derived hardware address after a second threshold number of proximity messages or after a second time period. The derived hardware address can change at a relatively rapid rate when the portable device 105 is in a near state, and the derived hardware address may rotate at a relatively slow rate for a far state portable device. Accordingly, the first time period can be shorter than the second time period and the first threshold can be smaller than the second threshold.

The electronic device 110 can use proximity messages received from portable device 105 to determine the portable device's state. The portable device 105 can be in a near state, when the device is in communication with (e.g., receiving reply messages from) a paired electronic device, or the device can be in a far state when the device is not in communication with (e.g., not receiving reply messages from) a paired electronic device. In some embodiments, the portable device 105 can determine whether the device is in a near state or a far state using information from the portable device without considering whether the device is receiving reply messages. The proximity message can be received at the electronic device communication module 125 and the module can provide the hardware address, timing information, and protocol identifier, from the proximity message to the mobile device state detection module 155.

The electronic device 110 may generate the derived hardware addresses that are used to determine if the mobile device is paired to the portable device 105. In some implementations, the mobile device state detection module 155 or a function within one of the applications can use the protocol identifier to retrieve a key derivation function (e.g., cryptographic information) from the server 135 via the electronic device communication module 125. The key derivation function can be used to generate derived hardware addresses from a hardware address that the portable device 105 provided to paired mobile devices during paring. The hardware address and timing information can be used as input to a key derivation function associated with the protocol identifier, and the key derivation function can output a derived hardware address. At least a portion of the output derived hardware addresses can be compared to at least a portion of the hardware addresses received from the portable device 105 to determine if the portable device 105 and electronic device 110 are or have previously been paired. In some embodiments, the hardware addresses provided by the portable device 105 may be partially masked. For example, the last six bytes of the hardware address may be hidden.

It is possible that there is a desynchronization between the clock in the portable device timing module 150 and the clock in the electronic device communication module 125. Desynchronized clocks can mean that the key derivation function has incorrect timing inputs, and that the function outputs an incorrect derived hardware address that does not match the received hardware address. To mitigate the possibility that a desynchronization causes the electronic device 110 to incorrectly determine that the mobile device is not paired with the portable device 105, the electronic device communication module 125 can use a range of timing information around the timing information received from the portable device communication module 120. This range of timing information can be used to generate a range of derived hardware addresses that can be compared to the derived hardware address received from the portable device communication module 120.

The electronic device 110 may be able to perform a local finding operation with portable device 105 if the devices are paired. The electronic device operation module 160 can communicate with the portable device operation module 165 to perform a local finding operation. The communication can occur via the electronic device communication module 125 and the portable device communication module 120.

A local finding operation can include operations to determine a distance between the electronic device 110 and the portable device 105. The local finding operation can include measuring the received signal strength indicator (RSSI) value for a proximity message that is exchanged between the devices. The local finding operation may include exchanging one or more ranging messages and using the time-of-flight and/or RSSI value for one or more of the ranging messages to determine a distance and/or orientation between the electronic device 110 and the portable device 105. In some embodiments, the local finding operation may include providing instructions from the electronic device 110 to the portable device 105. The instructions may cause the portable device 105 to emit a sound, vibrate, and/or activate a light. The local finding operation may include displaying a location of the portable device 105 on a map that is displayed by the electronic device 110.

A local finding operation can be performed between the electronic device 110 and the portable device 105 when the devices are not paired. For example, an associated device 170 may delegate local finding operation functionality to the electronic device 110. The associated devices 170 can be devices that are associated with the portable device 105. The associated devices 170 can include any combination of any number of the modules and functionality that is described with reference to electronic device 110. The associated devices 170 can be associated if cryptographic information that is associated with an account of the crowd sourced location service is authenticated on the portable device 105 and the authenticated device. The cryptographic information may be different across the associated devices 170 and the portable device 105. For example, a first cryptographic information that is associated with an account may be authenticated on an associated device 170, and a second cryptographic information associated with the account may be authenticated on the portable device 105. The server 135 may include a mapping of cryptographic information and accounts in some embodiments.

An associated device 170 may delegate local finding functionality to the electronic device 110 by providing cryptographic information for the portable device 105 to the electronic device 110. For example, the associated device 170 can provide cryptographic information for the portable device 105 to the electronic device 110. The cryptographic information can be some or all of a device identifier for the portable device 105, and the electronic device 110 can use the cryptographic information to identify the portable device 105. For example, the electronic device 110 may compare the cryptographic information against proximity message payloads to identify the portable device 105. In some embodiments, the associated device 170 may provide the cryptographic information to the electronic device 110 via the server 135. For example, the associated device 170 may provide a network identifier to the electronic device 110, and the electronic device 110 may use the network identifier to access the cryptographic information from the server 135. The associated device 170 may provide the cryptographic information to the electronic device 110 with a request to perform a local finding operation.

A local finding operation can be performed in response to input to the electronic device 110 that is received via input module 175. The input module 175 can cause the electronic device 110 to display a graphical user interface and a portable device 105 for a local finding operation can be selected via the graphical user interface. In response to the selection, the electronic device 110 can monitor the payloads of advertising messages to identify the selected device, and the electronic device 110 can establish a communication link with the selected device once the portable device 105 is detected using the cryptographic information. In some embodiments, the electronic device 110 has already established a communication link with the selected device, and the local finding operation can be performed without establishing the communication link in response to a request at the input module 175.

The local finding operation can include using ranging techniques to locate the electronic device 110 and the portable device 105. The ranging techniques may be used to determine any combination of any number of a distance between the devices, a direction from the electronic device 110 to the portable device 105, and a position of the portable device 105 on a map. Any combination of any number of the distance, direction, and map position may be displayed on a display device of the electronic device 110. The local finding operation may include providing instructions from the electronic device 110 to the portable device 105. For example, the electronic device 110 may instruct the portable device 105 to emit a sound, activate a light, or vibrate.

The portable device 105 may enter an activation locked state in some embodiments. For example, the activation lock module 180 may cause the portable device 105 to enter an activation locked state by limiting the device's input and output, controlling access to one or more applications or system processes, encrypting the device's memory, or otherwise limiting the portable device's functionality. The activation locked state may prevent the portable device 105 from having the device's memory wiped.

An associated device 170 may instruct the portable device to enter the activation locked state, and, in some embodiments, the instruction may be provided to the portable device 105 via the server 135 or the electronic device 110. For example, the portable device can instruct the server 135 record that the portable device 105 is in an activation locked state. The server 135 can provide an instruction to enter the activation locked state to the portable device 105 via the electronic device 110 if the electronic device's messages to the server 135 indicate that the electronic device 110 has received a far state message from the portable device 105 (e.g., the electronic device is in communication with the portable device). In some embodiments, the server 135 or the associated device 170 can provide an instruction to enter the activation locked sate to the portable device 105 via the portable device communication module 120. For example, the instruction can be sent via a network connection such as a cellular network or the Internet. The instruction can include cryptographic information and the portable device 105 may enter the activation locked state after authenticating the cryptographic information. In some embodiments, the portable device 105 may enter the activation locked state in response to an instruction that does not include cryptographic information.

The portable device 105 may exit the activation locked state in response to an instruction. For example, the portable device 105 may receive an instruction to exit the activation locked state from the portable device 105. The instruction may include cryptographic information and the portable device 105 may exit the locked state after authenticating the cryptographic information (e.g., using a public key to verify a token that was signed with a private key). The cryptographic information can be provided to the electronic device 110 by the server 135 or the associated devices 170. For example, the server 135 or the associated device 170 may sign a token with the cryptographic information and the signed token may be provided to the electronic device 110 via a network connection.

An associated device 170 may authorize the electronic device 110 to transfer an activation lock from the portable device 105 to a new electronic device. The new electronic device can be an electronic device like portable device 105 and transferring the activation lock can include transferring any combination of the settings, memory, and configurations of the portable device 105 to a new device. The new device can be associated with the associated devices 170. Transferring the activation lock can include instructing the server 135 to remove an association between the portable device 105 and an account of the location service. Transferring the activation lock may include instructing the server 135 to associate the new device with the account of the location service (e.g., account information). The association can be between cryptographic information and/or a hardware identifier the portable device 105 and account information including any combination of an account identifier, a phone number, and/or an email address. Transferring the cryptographic information may include creating new cryptographic information for the new device.

The associated device 170 may authorize the activation lock transfer. The server 135 may send a request to authorize the activation lock transfer to the associated device 170 as a push notification, a text message, an instant message, an email message, or a phone call. The associated device 170 may authorize the request by signing a token with cryptographic information, and the request can be provided to the server 135 and/or the electronic device 110. The electronic device 110 may provide the signed token to the portable device 105 with an instruction to remove the activation locked state, and the portable device 105 may remove the activation locked state after verifying the token. The electronic device 110 may obtain identifying information from a new device (e.g., a device that is receiving the transfer activation lock). The token and the identifying information (e.g., a hardware identifier) can be provided to the server 135 by the electronic device 110, and the server may associate the new device with an account identifier for an account that signed the token.

### I. Enabling Local Features

Portable devices in a crowd sourced location service may operate in two modes, a near mode when the portable device is near a paired computing device, and a far mode when the portable device is not in contact with a paired device.

The portable device can broadcast an anonymized identifier that is derived from cryptographic information. In a near mode, when the portable device is in communication with a paired computing device, the portable device may rotate the anonymized identifier at regular intervals (e.g., every 15 minutes). A paired computing device can identify the portable device using these rotating identifiers, and an unpaired device cannot use the anonymized identifier as a proxy for the portable device identifier because the anonymized identifier rotates regularly. Rotating means that the anonymized identifier changes frequently and a single identifier cannot be used to recognize the portable device. In a far mode, the anonymized identifier rotates at a far slower rate (e.g., daily vs. every 15 min). An unpaired computing device can detect that a portable device is in a far mode by detecting the same identifier over a longer period of time than would occur if the portable device was in a near mode. The unpaired computing device can report this identifier and a location to a server. The server can use cryptographic information to identify one or more paired devices that are associated with the anonymized identifier. After identifying the paired devices, the server can provide the portable device's location to the paired devices.

In a near mode, the paired computing device can use the cryptographic information to trigger certain functionality to help locate the portable device. For example, the paired device can cause the portable device to make a sound, vibrate, or otherwise provide information about the portable device's location. The paired device can also enable ranging or directional sound localization to help the paired device locate the portable device.

In certain circumstances, a paired device may wish to grant permission for an unpaired device to enable this functionality. For example, a user may place a portable device in luggage for air travel. The user may provide the luggage to the airline as checked baggage during check in for a flight. During the check in process, the user may provide a web link to the airline to enable the airline to monitor the luggage's location while the luggage is in the airline's custody.

The airline employees can use the link to view the luggage's location on a map (e.g., via a web browser). The airline may lose track of the user's luggage, and an airline employee may use the link to enable local control functionality to locate the lost luggage. However, it is important that this functionality is enabled in a way that does not allow for control of a device in a near state.

The web link can enable local finding of a portable device by a non-owner device (e.g., a third-party device). An unpaired device can use the web link to access cryptographic information to enable control of the tracking device. The unpaired device can identify the portable device by matching a portion of the portable device's public key to advertising messages. The portion can be the last six digits of the portable device's public key. In addition, the keys can be used to sign messages so that the unpaired device can control the portable device.

The portable device may only broadcast a portion of the public key in a near state, but the entire public key (or a different portion of the public key) may be broadcast in a far state. A paired device can recognize the portable device from the near state partial public key, and an unpaired device is not able to identify the portable device in a near state. Therefore, the unpaired device is not able to control the portable device in a near state because the unpaired device cannot identify the portable device.

Enabling local control features can improve the functioning of a computer system by enabling a third-party device to locate and control a portable device in a far state without enabling this functionality for a portable device in a near state. The portable device may broadcast different portions of the cryptographic information in a near state and a far state. A third-party device therefore can match the cryptographic information to the portable device's proximity message in a far state, but the same cryptographic information cannot be used to identify the portable device in a near state. Accordingly, the third-party device may only be able to locate and control the portable device when the device is not near a paired electronic device.

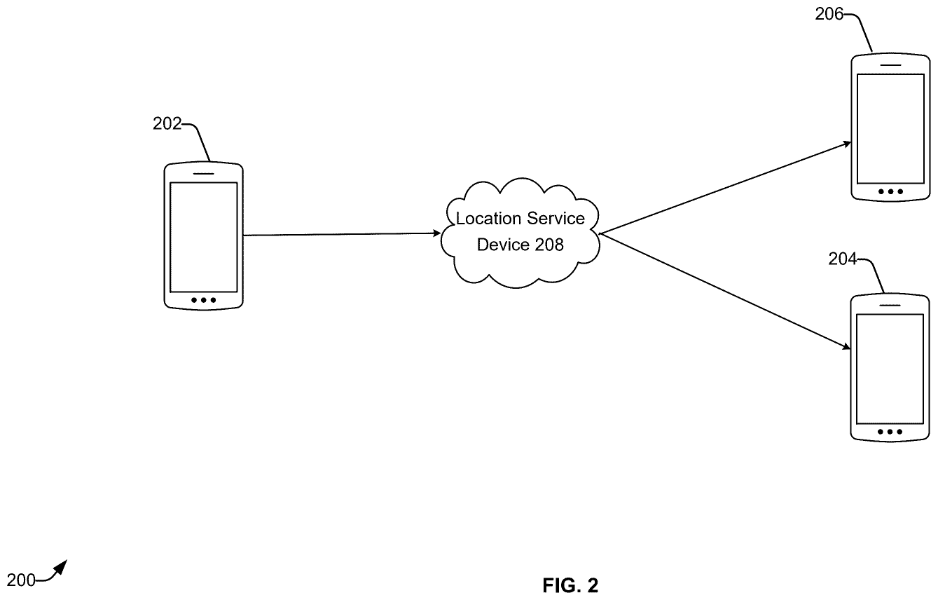

FIG. 2 is a simplified diagram of an architecture 100 for sharing permission to perform a local finding operation to a third-party device according to various embodiments. An electronic device 202 can authorize third party devices 204-206 to access cryptographic information for a portable device. For example, the electronic device 202 may authorize a dog daycare worker to access information for a location tag in a pet's collar so that the dog walker can locate the dog. The electronic device 202 can authorize a third party device by providing a portion of the portable device's cryptographic information to a location service device 208 (e.g., a server). The cryptographic information can be provided with information identifying the third-party devices 204-206.

The third-party devices 204-206 may be authorized to access the cryptographic information, but the devices may not access the cryptographic information until the devices attempt to locate the portable device. For example, the dog may be hiding in a play area and a dog daycare worker may want to make the tag beep to locate the dog. The daycare worker's third-party device 204 can send a request for the cryptographic information to the location service device 208. The request can include information identifying the portable device (e.g., the tag) and the third-party device 204. The location service device 208 can verify that the third-party device 204 is authorized to access the cryptographic information and the location service device 208 can send the information to the daycare worker's device. After receiving the cryptographic information, the third-party device 204 can identify the tag and perform a local finding operation to locate the dog.

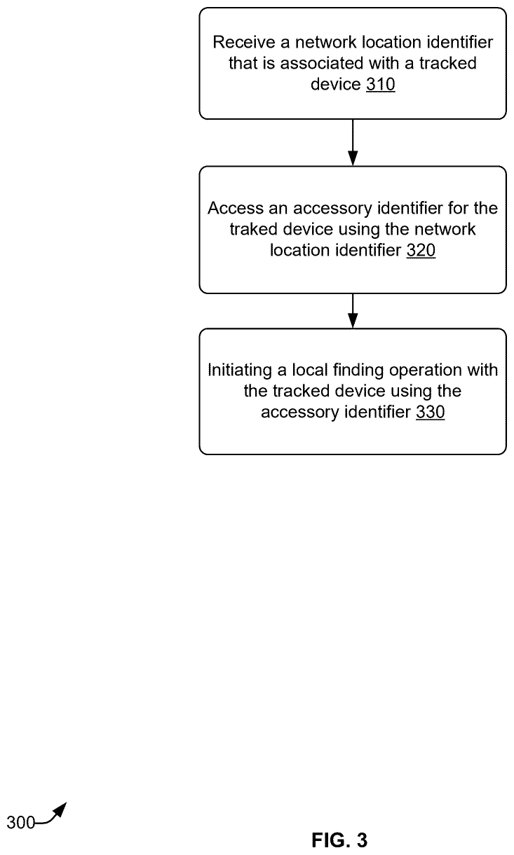

FIG. 3 is a flow chart of process 300 for techniques to initiate a local finding operation according to various embodiments. In some implementations, one or more process blocks of FIG. 3 can be performed by an electronic device such as portable device 105, electronic device 110, server 135, electronic device 800, mobile device 900, and mobile device 1000. In some implementations, one or more process blocks of FIG. 3 can be performed by another device or a group of devices separate from or including the electronic device.

At block 310, a network location identifier associated with a portable device can be received. The network location identifier can be a network address such as an internet protocol address (e.g., an IPv4 address or an IPV6 address), a telephone number, a media access control (MAC) address, and/or any other identifier suitable for identifying the portable device. In some embodiments, receiving the network location identifier may include receiving account information that can be used to obtain a network location identifier. For example, the account information can be an account identifier that is associated with the portable device, a serial number of the portable device, an email address, and/or any other information associated with an account that is associated with the portable device.

The network location identifier can be received from an electronic device that is associated with the portable device. The network location identifier can be received as a text message that is sent over a cellular network or an instant message sent via a messaging client application on the electronic device. In some embodiments, the network location identifier can be received as a push message via a location services application or system process.

An electronic device can be associated with the portable device if the portable device and the electronic device are associated with the same account information or cryptographic information. For example, the portable device can be registered with a location service using account information and an account associated with the account information can be authenticated on the electronic device.

At block 320 a tracking identifier for the portable device can be accessed using the network location identifier. To access the network location identifier, an electronic device can send a request to a computing device that corresponds to the network location identifier. The tracking identifier can be provided in response to the request. The tracking identifier may be cryptographic information that is associated with the portable device, and the tracking identifier can be broadcast by the portable device in a far mode. For example, the tracking identifier can be some or all of a public key that is included in the payload of the portable device's far mode advertising messages. In some embodiments, the tracking identifier may be the last six bytes of the far mode advertising message.

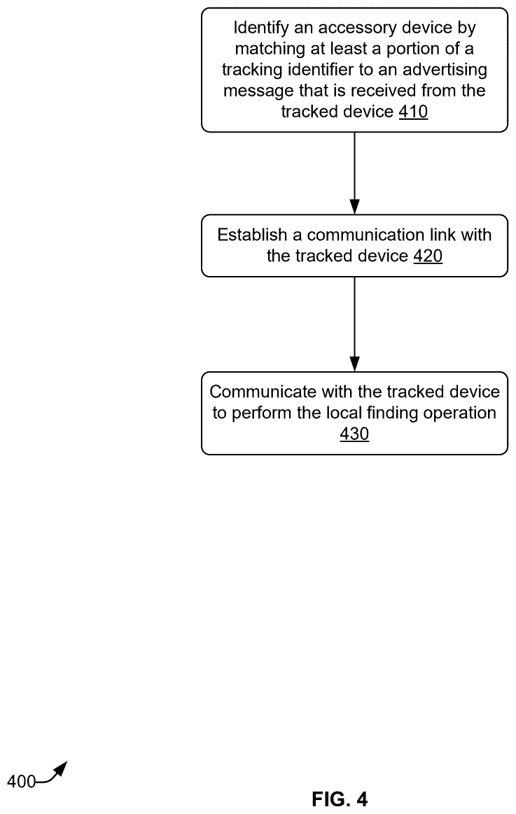

At block 330, a local finding operation can be initiated with the portable device using the tracking identifier. The local finding operation may be initiated by establishing a communication link with the portable device using the tracking identifier. Performing the local finding operation is described with reference to FIG. 4, and any of the techniques described with FIG. 4 can be combined with the techniques described with reference to FIG. 3.

Although FIG. 3 shows example steps of process 300, in some implementations, process 300 can include additional steps, fewer steps, different steps, or differently arranged steps than those depicted in FIG. 3. Additionally, or alternatively, two or more of the steps of process 300 can be performed in parallel.

FIG. 4 is a flow chart of process 400 for techniques to perform a local finding operation according to various embodiments. In some implementations, one or more process blocks of FIG. 4 can be performed by an electronic device such as portable device 105, electronic device 110, server 135, electronic device 800, mobile device 900, and mobile device 1000. In some implementations, one or more process blocks of FIG. 4 can be performed by another device or a group of devices separate from or including the electronic device.

At block 410, the portable device can be identified by matching at least a portion of the tracking identifier to an advertising message that is received from a portable device. For example, the tracking identifier can be the last eight bytes of a public key that is included in the advertising messages that are broadcast by the portable device.

At block 420, a communication link can be established with the portable device. The communication link can be a connection over a short-range communication protocol such as a Bluetooth connection or a Bluetooth Low Energy connection. The advertising message that is broadcast by the portable device can include connection information that can be used to connect with the portable device. For example, the connection information can include a schedule that identifies windows where the portable device will scan for a request to initiate a communication link. The connection information may include authentication information such as a signed token that the portable device can use to verify a connection request (e.g., using public key encryption techniques).

At block 430, a local finding operation can be performed by communicating with the portable device. Communication with the portable device can occur via the communication link. The local finding operation can be performed by instructing the portable device to emit a sound, vibrate, or turn on a light on the portable device.

The communication with the portable device can include exchanging ranging messages to determine a position of the portable device relative to the electronic device (e.g., electronic user device). Any combination of time of flight ranging techniques and received signal strength indicator (RSSI) ranging techniques can be used to determine the relative position of the portable device. The relative position can be any combination of a distance between the portable device and electronic device, and a direction between the portable device and the electronic device.

The electronic user device can present the relative position of the portable device on the user device's display. The relative position can be presented on a map, and, in some embodiments, the position of the electronic user device may be displayed on the map along with the relative position. The relative position may be used to present any combination of a distance and direction on the electronic user device's display. For example, the relative position can be used to generate a graphical arrow that points to the portable device.

Although FIG. 4 shows example steps of process 400, in some implementations, process 400 can include additional steps, fewer steps, different steps, or differently arranged steps than those depicted in FIG. 4. Additionally, or alternatively, two or more of the steps of process 400 can be performed in parallel.

### II. Activation Lock Transfers

A crowd sourced location service may offer location features including location monitoring, device control for local finding operations, and security features. The security features can include causing portable devices to enter an activation locked state under certain circumstances. A portable device in an activation locked state may have limited functionality until the device is unlocked. For example, the portable device can be a mobile phone that is associated with a location service account. The device may be prevented from launching applications or making calls until the account is authenticated on the device.

Authenticating the account may include providing cryptographic information that is associated with the account. A user associated with the account may wish to authorize a third-party device to remove or transfer location services from a first portable device to a second device. For example, the user may wish to authorize a technician's device so that the location features can be removed or transferred during device repair. The user can provide cryptographic information to the third-party device so that the device can be used to modify the location features. For example, the user's electronic device can use a private key to generate a signed token. The portable electronic device can authenticate the token using a public key that corresponds to the private key, and the device can leave the activation locked state after authenticating the token.

Authorizing a third-party device to remove or transfer location features can provide a technical benefit by improving a location service's security. Previously, a user may need to remove the location features from a portable device during repair. This meant that the location features were removed from a portable device when the device was outside of the user's custody when these features may be particularly useful. Accordingly, the disclosed techniques provide a technical benefit by enabling a specific third-party device to remove or transfer the location features from a portable device without removing the features from the device.

In an illustrative example, a portable device may enable location features during repair. If the device needs to be replaced, a technician can request that the location service transfer the cryptographic information for the device to a new device. The service can authenticate the request by sending a message to a trusted device that is associated with the same location service account as the device being repaired. For example, the trusted device can be a second device that has enabled location functionality with the same user account with the location service. The user of the trusted device can send a response authorizing the transfer, and a response can be signed with cryptographic information for the account. Upon receiving the response, the location features can be transferred from the old device to the new device. In some embodiments, the location service can transfer the location features to the new device by generating new cryptographic information and associating this new information with the account and the new device.

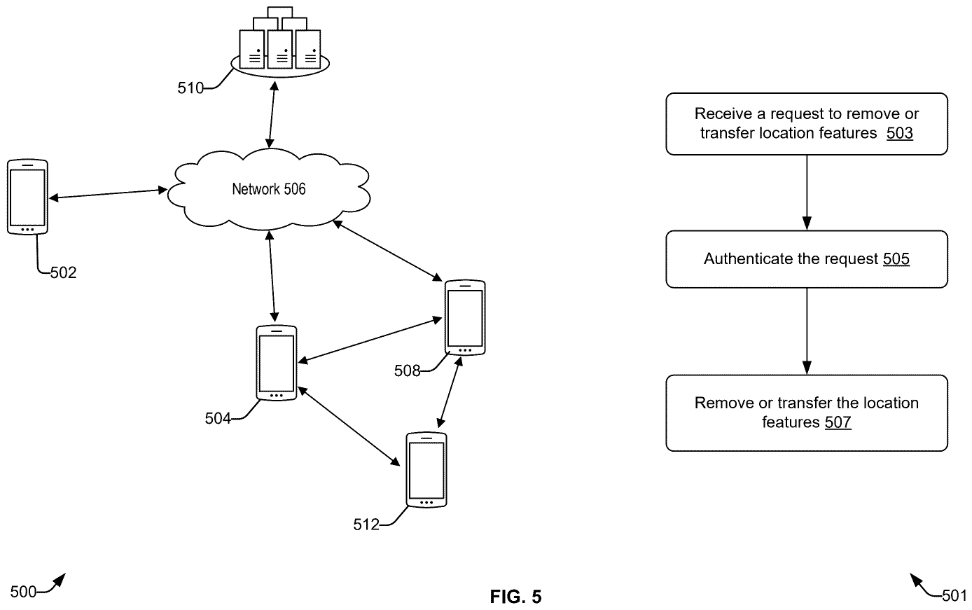

FIG. 5 is a simplified diagram 500 and a process 501 for an activation lock transfer according to various embodiments. Turning now to process 501, at block 503, a request to remove or transfer location features can be received. The request can be received at electronic device 502 from third-party electronic device 504 via network 506. The third-party electronic device may be a repair technician's device and the request may be to remove or transfer an activation locked state from electronic device 508. The electronic device 502 and the electronic device 508 may be associated with a crowd sourced location service, and the service may be implemented in part by a server 510. In some embodiments, the request can be received at the electronic device 502 via the server 510.

The electronic device 502 and the electronic device 508 may be associated with the same account because the account is authenticated on both devices or both devices are registered with the location service. The device may be registered with the service because the server 510 associates a device identifier for each device with an account identifier and cryptographic information. For example, the cryptographic information may include a private key and a public key. In some embodiments, the server 510 may store a separate private key/public key pair for each device that is registered with the account.

At block 505, the request can be authenticated. The electronic device 502 may authenticate the request using cryptographic information. For example, the electronic device 502 may authenticate the request by signing a token with a private key for the location service account that is associated with the electronic device 508.

At block 507, the location features can be removed or transferred. The location features can include an activation lock and removing the location features can mean instructing the electronic device 508 to remove the activation locked state. The instruction can be provided to the electronic device 508 by the third-party device 504 or the server 510, and the instruction can be provided with the signed token. The signed token can be provided to the electronic device 508 via network 506 and the device 508 can authenticate the request by verifying the token using a public key for the account. The electronic device 508 can remove the location features after verifying the token.

The location features can be transferred from the electronic device 508 to an electronic device 512. Transferring the location features can include removing the features from the electronic device 508. The third-party electronic device 504 can provide the token to the electronic device 508 and the electronic device 512. The token can be provided to the electronic device 508 with instructions to remove the location features, and the token can be provided to electronic device 512 with instructions to register the device with the server 510. The electronic device 512 can provide the token to the server 510 with a request to associate the device with the location service account, and the server 510 can associate the device 512 with the account after verifying the token.

Although FIG. 5 shows example steps of process 501, in some implementations, process 501 can include additional steps, fewer steps, different steps, or differently arranged steps than those depicted in FIG. 5. Additionally, or alternatively, two or more of the steps of process 501 can be performed in parallel.

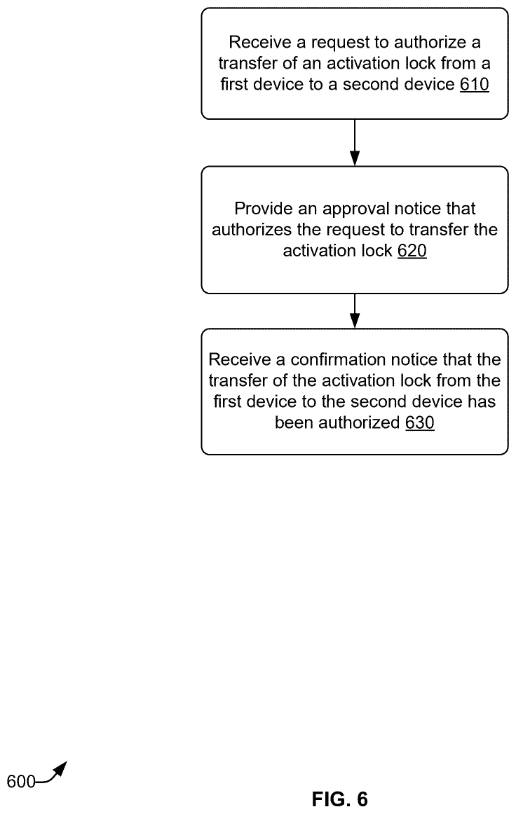

FIG. 6 is a flow chart of process 600 for techniques to verify a request to authorize an activation lock transfer according to various embodiments. In some implementations, one or more process blocks of FIG. 6 can be performed by an electronic device such as portable device 105, electronic device 110, server 135, electronic device 800, mobile device 900, and mobile device 1000. In some implementations, one or more process blocks of FIG. 6 can be performed by another device or a group of devices separate from or including the electronic device.

At block 610, a request to authorize a transfer of an activation lock from a first device to a second device can be received by a computing device. The activation locked state is enabled on the first device, and the activation lock can be for an account (e.g., associated with an account) of a location service. An account that is associated with an activation lock on a device can be used to unlock the device by authenticating the account on the device. For example, an account identifier and a password can be provided to an activation locked device and the device can use this authentication information to remove the lock after authenticating the account. The account can be authenticated on the electronic device that has received the request. The request may be received on the electronic device as any combination of any number of a push message, a text message, an instant message, a phone call, and an email message.

At block 620, an approval notice that authorizes the request to transfer the activation lock can be provided. The approval can include authentication information for the account of the location service. In some embodiments, the request from 610 may cause the electronic device that has received the request to present a webpage on a web browser application. The electronic device can authorize the request by providing authentication information for the account via the webpage.

At block 630, a confirmation notice that the transfer of the activation lock from the first device to the second device has been authorized. The request can be received from any combination of any number of the first device, the second device and the computing device. An indication of the transfer of the activation lock from the first device can be received from any combination of any number of the first device, the second device and the computing device. The transfer of the activation lock may be authorized for a time period and the transfer may be deauthorized at a conclusion of the time period. An indication that the transfer of the activation lock from the first device to the second device has been deauthorized may be received from any combination of any number of the first device, the second device and the computing device Although FIG. 6 shows example steps of process 600, in some implementations, process 600 can include additional steps, fewer steps, different steps, or differently arranged steps than those depicted in FIG. 6. Additionally, or alternatively, two or more of the steps of process 600 can be performed in parallel.

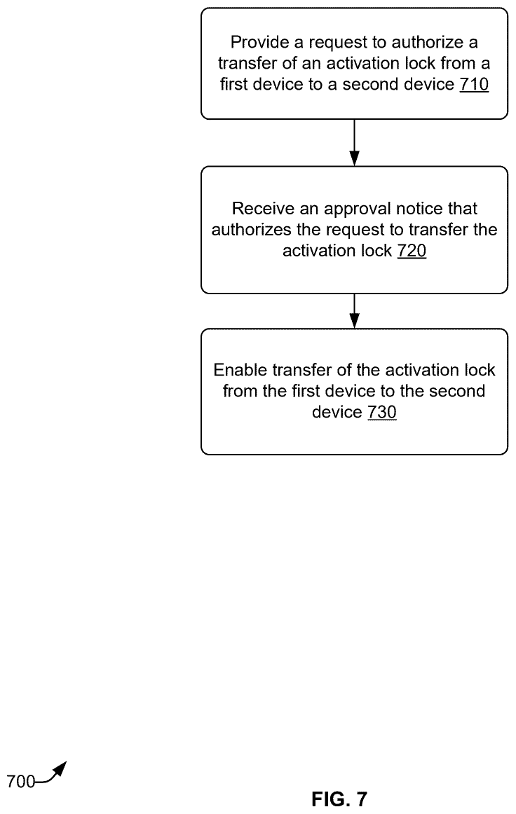

FIG. 7 is a flow chart of process 700 for techniques to request an authorization lock transfer according to various embodiments. In some implementations, one or more process blocks of FIG. 7 can be performed by an electronic device such as portable device 105, electronic device 110, server 135, electronic device 800, mobile device 900, and mobile device 1000. In some implementations, one or more process blocks of FIG. 7 can be performed by another device or a group of devices separate from or including the electronic device.

At block 710, a request to authorize a transfer of an activation lock for an account of a location service from a first device to a second device can be provided. The first device can be in an activation locked state and the account of the location service can be authenticated on the first device.

At block 720, an approval notice that approves the request to transfer the activation lock can be received at the computing device. The approval notice can include authentication information for the account. For example, the authentication information can be any combination of any number of a token that is signed by a private key of the account, and the login credentials for the account.

At block 730, a transfer of the activation lock from the first device to the second device can be enabled. The second device can be in an activation locked state after the transfer of the activation lock from the first device to the second device. Transferring the activation lock from the first device can include providing the authentication information to the first device. Transferring the activation lock can include wiping the memory of the first device.

Although FIG. 7 shows example steps of process 700, in some implementations, process 700 can include additional steps, fewer steps, different steps, or differently arranged steps than those depicted in FIG. 7. Additionally, or alternatively, two or more of the steps of process 700 can be performed in parallel.

### III. Portable Devices and Uses Thereof

Tracking functionality can be beneficial in both business and personal settings. For instance, an employer may want to track inventory in a business' warehouse, or a parent may want to locate a child's lost backpack. As described herein, portable devices can be used to implement various tracking functionalities.

A. Example device architecture

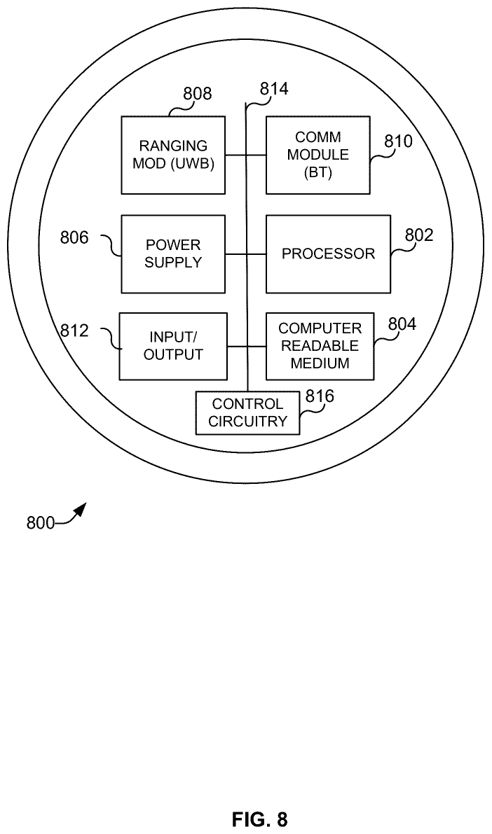

FIG. 8 is a block diagram of an example tracked electronic device 800 according to various embodiments. Device 800 generally includes one or more processor(s) 802, a computer-readable medium 804, a power system 806, a ranging module 808, a communication module (e.g., Bluetooth), and I/O subsystem 812. These components may be coupled by one or more communication buses or signal lines 814. Device 800 can be any electronic device, including a portable electronic device, a handheld computer, a tablet computer, a mobile phone, a laptop computer, a tablet device, a media player, personal digital assistant (PDA), a key fob, a car key, an electronic tag, an access card, a multifunction device, a mobile phone, a portable gaming device, a headset, or the like, including a combination of two or more of these items.

It should be apparent that the architecture shown in FIG. 8 is only one example of an architecture for device 800, and that device 800 can have more or fewer components than shown, or a different configuration of components. The various components shown in FIG. 8 can be implemented in hardware, software, or a combination of both hardware and software, including one or more signal processing and/or application specific integrated circuits. Although the electronic device 800 is depicted as being round in shape it is not so limited.

A communication module 810 can include wireless circuitry that can be used to send and receive information over a wireless link or network to one or more other devices' conventional circuitry such as an antenna system, a radio frequency (RF) transceiver, one or more amplifiers, a tuner, one or more oscillators, a digital signal processor, a CODEC chipset, memory, etc. Wireless circuitry can use various protocols, e.g., as described herein. In various embodiments, wireless circuitry is capable of establishing and maintaining communications with other devices using one or more communication protocols, including time division multiple access (TDMA), code division multiple access (CDMA), global system for mobile communications (GSM), Enhanced Data GSM Environment (EDGE), wideband code division multiple access (W-CDMA), Long Term Evolution (LTE), Long-term Evolution (LTE)-Advanced, Wi-Fi (such as Institute of Electrical and Electronics Engineers (IEEE) 802.11a, IEEE 802.11b, IEEE 802.11g and/or IEEE 802.11n), Bluetooth, Wi-MAX, voice over Internet Protocol (VOIP), near field communication protocol (NFC), a protocol for email, instant messaging, and/or a short message service (SMS), or any other suitable communication protocol, including communication protocols not yet developed as of the filing date of this document.

One or more processor(s) 802 communicate with computer-readable medium 804. Computer-readable medium 804 can be any device or medium that can store code and/or data for use by one or more processor(s) 802. Computer-readable medium 804 can include a memory hierarchy, including cache, main memory, and secondary memory. The memory hierarchy can be implemented using any combination of RAM (e.g., Standard Random Access Memory (SRAM), Dynamic Random Access Memory (DRAM), Double Data Random Access Memory (DDRAM), Read only Memory (ROM), FLASH, magnetic and/or optical storage devices, such as disk drives, magnetic tape, CDs (compact disks) and DVDs (digital video discs)).

Processor(s) 802 can include hardware and/or software elements that perform one or more processing functions, such as mathematical operations, logical operations, data manipulation operations, data transfer operations, controlling the reception of user input, controlling output of information to users, or the like. Processor(s) 802 can be embodied as one or more hardware processors, microprocessors, microcontrollers; field programmable gate arrays (FPGAs), application-specified integrated circuits (ASICs), or the like.

Device 800 may include storage and processing circuitry such as control circuitry 816. Control circuitry 816 may include storage such as hard disk drive storage, nonvolatile memory (e.g., flash memory or other electrically-programmable-read-only memory configured to form a solid-state drive), volatile memory (e.g., static or dynamic random-access-memory), etc. Processing circuitry in control circuitry 816 may be used to control the operation of device 800. This processing circuitry may be based on one or more microprocessors, microcontrollers, digital signal processors, baseband processor integrated circuits, application specific integrated circuits, etc.

Control circuitry 816 may be used to run software on device 800, such as location applications, internet browsing applications, voice-over-internet-protocol (VOIP) telephone call applications, email applications, media playback applications, operating system functions, etc. To support interactions with external equipment, control circuitry 816 may be used in implementing communications protocols. Communications protocols that may be implemented using control circuitry 816 include internet protocols, wireless local area network protocols (e.g., IEEE 802.11 protocols—sometimes referred to as Wi-Fi®), protocols for other short-range wireless communications links such as the Bluetooth® protocol, cellular telephone protocols, multiple-input and multiple-output (MIMO) protocols, antenna diversity protocols, satellite navigation system protocols, millimeter wave communications protocols, IEEE 802.15.4 ultra-wideband communications protocols, etc.

Device 800 may include I/O subsystem 812. I/O subsystem 812 may include input-output devices. Input-output devices may be used to allow data to be supplied to device 800 and to allow data to be provided from device 800 to external devices. Input-output devices may include user interface devices, data port devices, and other input-output components. For example, input-output devices may include one or more displays (e.g., touch screens or displays without touch sensor capabilities), one or more image sensors (e.g., digital image sensors), motion sensors, and speakers. Input-output device may also include buttons, joysticks, scrolling wheels, touch pads, key pads, keyboards, microphones, haptic elements such as vibrators and actuators, status indicators, light sources, audio jacks and other audio port components, digital data port devices, light sensors, capacitance sensors, proximity sensors (e.g., a capacitive proximity sensor and/or an infrared proximity sensor), magnetic sensors, and other sensors and input-output components.

Device 800 also includes a power system 806 for powering the various hardware components. Power system 806 can include a power management system, one or more power sources (e.g., battery, alternating current (AC)), a recharging system, a power failure detection circuit, a power converter or inverter, a power status indicator (e.g., a light emitting diode (LED)) and any other components typically associated with the generation, management and distribution of power in mobile devices.

In some embodiments, device 800 includes an image sensor (e.g., a camera). In some embodiments, device 800 includes sensors. Sensors can include accelerometers, compass, gyrometer, pressure sensors, audio sensors, light sensors, barometers, and the like. Sensors can be used to sense location aspects, such as auditory or light signatures of a location.

In some embodiments, device 800 can include a GPS receiver, sometimes referred to as a GPS unit. A mobile device can use a satellite navigation system, such as the Global Positioning System (GPS), to obtain position information, timing information, altitude, or other navigation information. During operation, the GPS unit can receive signals from GPS satellites orbiting the Earth. The GPS unit analyzes the signals to make a transit time and distance estimation. The GPS unit can determine the current position (current location) of the mobile device. Based on these estimations, the mobile device can determine a location fix, altitude, and/or current speed. A location fix can be geographical coordinates such as latitudinal and longitudinal information.

One or more processor(s) 802 run various software components stored in computer-readable medium 804 to perform various functions for device 800. In some embodiments, the software components include an operating system, a communication module 810 (or set of instructions), a location module (or set of instructions), a ranging module 808 that is used as part of ranging operation described herein, and other application programs (or set of instructions).

The operating system can be any suitable operating system, including iOS, Mac OS, Darwin, Quatros Real-Time Operating System (RTXC), LINUX, UNIX, OS X, WINDOWS, or an embedded operating system such as VxWorks. The operating system can include various procedures, sets of instructions, software components, and/or drivers for controlling and managing general system tasks (e.g., memory management, storage device control, power management, etc.) and facilitates communication between various hardware and software components.

Communication module 810 facilitates communication with other devices over one or more external ports or via wireless circuitry and includes various software components for handling data received from wireless circuitry and/or external port. The external port (e.g., universal serial bus (USB), FireWire, Lightning connector, 80-pin connector, etc.) is adapted for coupling directly to other devices or indirectly over a network (e.g., the Internet, wireless LAN, etc.).

Location/motion module can assist in determining the current position (e.g., coordinates or other geographic location identifiers) and motion of device 800. Modern positioning systems include satellite based positioning systems, such as Global Positioning System (GPS), cellular network positioning based on “cell IDs,” and Wi-Fi positioning technology based on a Wi-Fi networks. GPS also relies on the visibility of multiple satellites to determine a position estimate, which may not be visible (or have weak signals) indoors or in “urban canyons.” In some embodiments, location/motion module receives data from GPS unit 848 and analyzes the signals to determine the current position of the mobile device. In some embodiments, location/motion module can determine a current location using Wi-Fi or cellular location technology. For example, the location of the mobile device can be estimated using knowledge of nearby cell sites and/or Wi-Fi access points with knowledge also of their locations. Information identifying the Wi-Fi or cellular transmitter is received at wireless circuitry and is passed to location/motion module. In some embodiments, the location module receives the one or more transmitter IDs. In some embodiments, a sequence of transmitter IDs can be compared with a reference database (e.g., Cell ID database, Wi-Fi reference database) that maps or correlates the transmitter IDs to position coordinates of corresponding transmitters, and computes estimated position coordinates for device 800 based on the position coordinates of the corresponding transmitters. Regardless of the specific location technology used, location/motion module receives information from which a location fix can be derived, interprets that information, and returns location information, such as geographic coordinates, latitude/longitude, or other location fix data.

Ranging module 808 can send/receive ranging messages to/from an antenna, e.g., connected to wireless circuitry. The messages can be used for various purposes, e.g., to identify a sending antenna of a device, determine timestamps of messages to determine a distance of mobile device 800 from another device. Ranging module 808 can exist on various processors of the device, e.g., an always-on processor (AOP), a UWB chip, and/or an application processor. For example, parts of ranging module 808 can determine a distance on an AOP, and another part of the ranging module can interact with a sharing module, e.g., to display a position of the other device on a screen in order for a user to select the other device to share a data item. Ranging module 808 can also interact with a reminder module that can provide an alert based on a distance from another mobile device.

Dielectric-filled openings such as plastic-filled openings may be formed in metal portions of housing such as in metal sidewall structures (e.g., to serve as antenna windows and/or to serve as gaps that separate portions of antennas from each other).

Antennas may be mounted in housing. If desired, some of the antennas (e.g., antenna arrays that may implement beam steering, etc.) may be mounted under dielectric portions of device 800 (e.g., portions of the display cover layer, portions of a plastic antenna window in a metal housing sidewall portion of housing, etc.). With one illustrative configuration, some or all of the rear face of device 800 may be formed from a dielectric. For example, the rear wall of housing may be formed from glass plastic, ceramic, other dielectric. In this type of arrangement, antennas may be mounted within the interior of device 800 in a location that allows the antennas to transmit and receive antenna signals through the rear wall of device 800 (and, if desired, through optional dielectric sidewall portions in housing). Antennas may also be formed from metal sidewall structures in housing and may be located in peripheral portions of device 800.

To avoid disrupting communications when an external object such as a human hand or other body part of a user blocks one or more antennas, antennas may be mounted at multiple locations in housing. Sensor data such as proximity sensor data, real-time antenna impedance measurements, signal quality measurements such as received signal strength information, and other data may be used in determining when one or more antennas are being adversely affected due to the orientation of housing, blockage by a user's hand or other external object, or other environmental factors. Device 800 can then switch one or more replacement antennas into use in place of the antennas that are being adversely affected.

Antennas may be mounted at the corners of housing, along the peripheral edges of housing, on the rear of housing, under the display cover layer that is used in covering and protecting the display on the front of device 800 (e.g., a glass cover layer, a sapphire cover layer, a plastic cover layer, other dielectric cover layer structures, etc.), under a dielectric window on a rear face of housing or the edge of housing, under a dielectric rear wall of housing, or elsewhere in device 800. As an example, antennas may be mounted at one or both ends of device 800 (e.g., along the upper and lower edges of housing, at the corners of housing, etc.).

Antennas in device 800 may include cellular telephone antennas, wireless local area network antennas (e.g., Wi-Fi® antennas at 2.4 GHz and 5 GHz and other suitable wireless local area network antennas), satellite navigation system signals, and near-field communications antennas. The antennas may also include antennas that support IEEE 802.15.4 ultra-wideband communications protocols and/or antennas for handling millimeter wave communications. For example, the antennas may include two or more ultra-wideband frequency antennas and/or millimeter wave phased antenna arrays. Millimeter wave communications, which are sometimes referred to as extremely high frequency (EHF) communications, involve signals at 60 GHz or other frequencies between about 10 GHz and 400 GHz.

Wireless circuitry in device 800 may support communications using the IEEE 802.15.4 ultra-wideband protocol. In an IEEE 802.15.4 system, a pair of devices may exchange wireless time stamped messages. Time stamps in the messages may be analyzed to determine the time of flight of the messages and thereby determine the distance (range) between the devices.

Image sensors may include one or more visible digital image sensors (visible-light cameras) and/or one or more infrared digital image sensors (infrared-light cameras). Image sensors may, if desired, be used to measure distances. For example, an infrared time-of-flight image sensor may be used to measure the time that it takes for an infrared light pulse to reflect back from objects in the vicinity of device 800, which may in turn be used to determine the distance to those objects. Visible imaging systems such as a front and/or rear-facing camera in device 800 may also be used to determine the position of objects in the environment. For example, control circuitry may use image sensors to perform simultaneous localization and mapping (SLAM). SLAM refers to the process of using images to determine the position of objects in the environment while also constructing a representation of the imaged environment. Visual SLAM techniques include detecting and tracking certain features in images such as edges, textures, room corners, window corners, door corners, faces, sidewalk edges, street edges, building edges, tree trunks, and other prominent features. Control circuitry 816 may rely entirely upon image sensors to perform simultaneous localization and mapping, or control circuitry 816 may synthesize image data with range data from one or more distance sensors (e.g., light-based proximity sensors). If desired, control circuitry 816 may use the display to display a visual representation of the mapped environment.

Input-output devices may include motion sensor circuitry. Motion sensor circuitry may include one or more accelerometers (e.g., accelerometers that measure acceleration along one, two, or three axes), gyroscopes, barometers, magnetic sensors (e.g., compasses), image sensors (e.g., image sensor) and other sensor structures. Sensors may, for example, include one or more microelectromechanical systems (MEMS) sensors (e.g., accelerometers, gyroscopes, microphones, force sensors, pressure sensors, capacitive sensors, or any other suitable type of sensor formed using microelectromechanical systems technology).

Control circuitry 816 may be used to store and process motion sensor data. If desired, motion sensors, processing circuitry, and storage that form motion sensor circuitry may form part of a system-on-chip integrated circuit (as an example).

Input-output devices may include movement generation circuitry. Movement generation circuitry may receive control signals from control circuitry 816. Movement generation circuitry may include electromechanical actuator circuitry that, when driven, moves device 800 in one or more directions. For example, movement generation circuitry may laterally move device 800 and/or may rotate device 800 around one or more axes of rotation. Movement generation circuitry may, for example, include one or more actuators formed at one or more locations of device 800. When driven by a motion control signal, actuators may move (e.g., vibrate, pulse, tilt, push, pull, rotate, etc.) to cause device 800 to move or rotate in one or more directions. The movement may be slight (e.g., not noticeable or barely noticeable to a user of device 800), or the movement may be substantial. Actuators may be based on one or more vibrators, motors, solenoids, piezoelectric actuators, speaker coils, or any other desired device capable of mechanically (physically) moving device 800.

Some or all of movement generation circuitry such as actuators may be used to perform operations that are unrelated to rotation of device 800. For example, actuators may include vibrators that are actuated to issue a haptic alert or notification to a user of device 800. Such alerts may include, for example, a received text message alert identifying that device 800 has received a text message, a received telephone call alert, a received email alert, an alarm notification alert, a calendar notification alert, or any other desired notification. By actuating the actuator, device 800 may inform the user of any desired device condition. For instance, the actuators may be vibrators can be actuated to identify the devices location to a user or a third party.

Motion sensor circuitry may sense motion of device 800 that is generated by movement generation circuitry. If desired, motion sensor circuitry may provide feedback signals associated with the sensed motion of device 800 to movement generation circuitry. Movement generation circuitry may use the feedback signals to control actuation of the movement generation circuitry.

Control circuitry 816 may use motion sensor circuitry and/or movement generation circuitry to determine the angle of arrival of wireless signals received by device 800 from another electronic device. For example, control circuitry 816 may use movement generation circuitry to move device 800 from one position to another. Motion sensor circuitry may be used to track the movement of device 800 as it is moved between the different positions. At each position, control circuitry 816 may receive wireless signals from another electronic device. Control circuitry 816 may process the received wireless signals together with the motion data from motion sensor circuitry to more accurately determine the position of the other electronic device. The use of motion generation circuitry is merely illustrative, however. If desired, motion sensor circuitry may track movement of device 800 that is not caused by motion generation circuitry. This may include a user's natural, unprompted movement of device 800 and/or the user's movement of device 800 after the user is prompted (by display, audio circuitry, a haptic output device in device 800, or any other suitable output device) to move device 800 in a particular fashion.

Other sensors that may be included in input-output devices include ambient light sensors for gathering information on ambient light levels, proximity sensor components (e.g., light-based proximity sensors, capacitive proximity sensors, and/or proximity sensors based on other structures), depth sensors (e.g., structured light depth sensors that emit beams of light in a grid, a random dot array, or other pattern, and that have image sensors that generate depth maps based on the resulting spots of light produced on target objects), sensors that gather three-dimensional depth information using a pair of stereoscopic image sensors, LIDAR (light detection and ranging) sensors, radar sensors, and other suitable sensors.

Input-output circuitry may include wireless communications circuitry for communicating wirelessly with external equipment. Wireless communications circuitry may include radio frequency (RF) transceiver circuitry formed from one or more integrated circuits, power amplifier circuitry, low-noise input amplifiers, passive RF components, one or more antennas, transmission lines, and other circuitry for handling RF wireless signals. Wireless signals can also be sent using light (e.g., using infrared communications).

Communications module 810 may include radio-frequency transceiver circuitry for handling various radio-frequency communications bands. For example, communication module 810 may include transceiver circuitry.

Transceiver circuitry may be wireless local area network transceiver circuitry. Transceiver circuitry may handle 2.4 GHz and 5 GHz bands for Wi-Fi® (IEEE 802.11) communications and may handle the 2.4 GHz Bluetooth® communications band.

Circuitry may use cellular telephone transceiver circuitry for handling wireless communications in frequency ranges such as a communications band from 900 to 960 MHz, a band from 1710 to 2170 MHz, a band from 2300 to 2700 MHz, other bands between 700 and 2700 MHz, higher bands such as LTE bands 42 and 43 (3.4-3.6 GHz), or other cellular telephone communications bands. Circuitry may handle voice data and non-voice data.

Millimeter wave transceiver circuitry (sometimes referred to as extremely high frequency transceiver circuitry) may support communications at extremely high frequencies (e.g., millimeter wave frequencies such as extremely high frequencies of 10 GHz to 400 GHz or other millimeter wave frequencies). For example, circuitry may support IEEE 802.11ad communications at 60 GHz. Circuitry may be formed from one or more integrated circuits (e.g., multiple integrated circuits mounted on a common printed circuit in a system-in-package device, one or more integrated circuits mounted on different substrates, etc.).

Ultra-wideband transceiver circuitry may support communications using the IEEE 802.15.4 protocol and/or other wireless communications protocols. Ultra-wideband wireless signals may be characterized by bandwidths greater than 500 MHz or bandwidths exceeding 20% of the center frequency of radiation. The presence of lower frequencies in the baseband may allow ultra-wideband signals to penetrate through objects such as walls. Transceiver circuitry may operate in a 2.4 GHz frequency band, a 6.5 GHz frequency band, an 8 GHz frequency band, and/or at other suitable frequencies.

Wireless communications circuitry may include satellite navigation system circuitry such as Global Positioning System (GPS) receiver circuitry for receiving GPS signals at 1575 MHz or for handling other satellite positioning data (e.g., GLONASS signals at 1609 MHz). Satellite navigation system signals for a receiver are received from a constellation of satellites orbiting the earth.

In satellite navigation system links, cellular telephone links, and other long-range links, wireless signals are typically used to convey data over thousands of feet or miles. In Wi-Fi® and Bluetooth® links at 2.4 and 5 GHz and other short-range wireless links, wireless signals are typically used to convey data over tens or hundreds of feet. Extremely high frequency (EHF) wireless transceiver circuitry may convey signals over these short distances that travel between transmitter and receiver over a line-of-sight path. To enhance signal reception for millimeter wave communications, phased antenna arrays and beam steering techniques may be used (e.g., schemes in which antenna signal phase and/or magnitude for each antenna in an array is adjusted to perform beam steering). Antenna diversity schemes may also be used to ensure that the antennas that have become blocked or that are otherwise degraded due to the operating environment of device 800 can be switched out of use and higher-performing antennas used in their place.

Wireless communications circuitry can include circuitry for other short-range and long-range wireless links if desired. For example, wireless communications circuitry 836 may include circuitry for receiving television and radio signals, paging system transceivers, near field communications (NFC) circuitry, etc.

The one or more applications on device 800 can include any applications installed on the device 800, including without limitation, a browser, address book, contact list, email, instant messaging, social networking, word processing, keyboard emulation, widgets, JAVA-enabled applications, encryption, digital rights management, voice recognition, voice replication, a music player (which plays back recorded music stored in one or more files, such as MP3 or advanced audio codec (AAC) files), etc.

There may be other modules or sets of instructions (not shown), such as a graphics module, a time module, etc. For example, the graphics module can include various conventional software components for rendering, animating and displaying graphical objects (including without limitation text, web pages, icons, digital images, animations, and the like) on a display surface. In another example, a timer module can be a software timer. The output of the timing module can be a local time (e.g., a current time in a particular time zone). The timer module can also be implemented in hardware. The time module can maintain various timers for any number of events.

I/O subsystem 812 can be coupled to a display system (not shown), which can be a touch-sensitive display. The display displays visual output to the user in a GUI. The visual output can include text, graphics, video, and any combination thereof. Some or all of the visual output can correspond to user-interface objects. A display can use LED (light emitting diode), LCD (liquid crystal display) technology, or LPD (light emitting polymer display) technology, although other display technologies can be used in other embodiments.

In some embodiments, I/O subsystem 812 can include a display and user input devices such as a keyboard, mouse, and/or trackpad. In some embodiments, I/O subsystem 812 can include a touch-sensitive display. A touch-sensitive display can also accept input from the user based at least in part on haptic and/or tactile contact. In some embodiments, a touch-sensitive display forms a touch-sensitive surface that accepts user input. The touch-sensitive display/surface (along with any associated modules and/or sets of instructions in computer-readable medium) detects contact (and any movement or release of the contact) on the touch-sensitive display and converts the detected contact into interaction with user-interface objects, such as one or more soft keys, that are displayed on the touch screen when the contact occurs. In some embodiments, a point of contact between the touch-sensitive display and the user corresponds to one or more digits of the user. The user can make contact with the touch-sensitive display using any suitable object or appendage, such as a stylus, pen, finger, and so forth. A touch-sensitive display surface can detect contact and any movement or release thereof using any suitable touch sensitivity technologies, including capacitive, resistive, infrared, and surface acoustic wave technologies, as well as other proximity sensor arrays or other elements for determining one or more points of contact with the touch-sensitive display.

Further, I/O subsystem 812 can be coupled to one or more other physical control devices (not shown), such as pushbuttons, keys, switches, rocker buttons, dials, slider switches, sticks, LEDs, etc., for controlling or performing various functions, such as power control, speaker volume control, ring tone loudness, keyboard input, scrolling, hold, menu, screen lock, clearing and ending communications and the like. In some embodiments, in addition to the touch screen, device 800 can include a touchpad (not shown) for activating or deactivating particular functions. In some embodiments, the touchpad is a touch-sensitive area of the device 800 that, unlike the touch screen, does not display visual output. The touchpad can be a touch-sensitive surface that is separate from the touch-sensitive display or an extension of the touch-sensitive surface formed by the touch-sensitive display.

In some embodiments, some or all of the operations described herein can be performed using an application executing on the user's device. Circuits, logic modules, processors, and/or other components may be configured to perform various operations described herein. Those skilled in the art will appreciate that, depending on implementation, such configuration can be accomplished through design, setup, interconnection, and/or programming of the particular components and that, again depending on implementation, a configured component might or might not be reconfigurable for a different operation. For example, a programmable processor can be configured by providing suitable executable code; a dedicated logic circuit can be configured by suitably connecting logic gates and other circuit elements; and so on.

### B. Use As a Portable Device

Electronic device 800 can be a portable electronic device that is configured to perform tracking functionality. This tracking functionality can include various position and location techniques including global positioning system (GPS) enabled tracking or Bluetooth low energy (BLE) enabled tracking using one or more of time of flight (ToF) calculations and received signal strength indicator (RSSI) measurements. The techniques can include Bluetooth crowd-sourcing, GPS/GNSS location, WiFi location, cellular location, etc. The location may be provided by the portable device or via a device in communication with the portable device. For example, a mobile phone can detect the presence of a portable device and provide location information to a server in connection with an identifier of the portable device. Control circuitry 817 can generate the identifier, such as a derived hardware address, using a key derivation function. A private key, such as a hardware address of device 800 can be input to the derivation function and control circuitry 817 can calculate a derived hardware address as an output from the function. In some embodiments, control circuitry 817 can retrieve a derived hardware address from a precalculated table of hardware addresses.

Location information for the portable electronic device can be provided, via a network connection, to an electronic device with permission to track the portable electronic device. This location information can allow the electronic device to monitor the location of the portable electronic device. The portable electronic device can report its location using a network connection such as a personal area network (e.g., when the two devices are near each other), a cellular network, an internet connection, etc. When using a personal area network, such as Bluetooth, the electronic device may receive a notification when the network connection is lost. This notification can inform the electronic device's user that the portable electronic device is no longer near the electronic device.

The portable electronic device can be tracked through a crowdsourced network of electronic devices using a combination of network connection such as personal area networks and wide area networks. Periodically, the portable electronic device can transmit proximity messages to nearby electronic devices over the personal area network, and a recipient of a proximity message can provide tracking information, including one or more of the message's payload, timing information, and location, to a tracking system using a wide area network. The tracking system can use the tracking information to create a log of the portable electronic device's movements that can be accessed by the portable electronic device's user. The tracking information may be encrypted, modified, anonymized, or hidden from the recipient electronic device to protect the privacy of the portable electronic device's user.

### IV. Example Devices

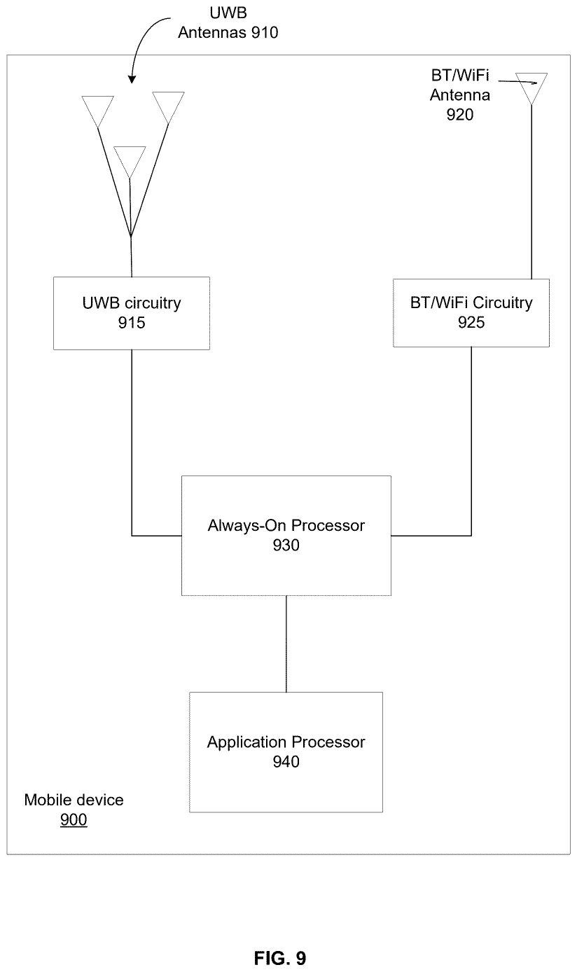

FIG. 9 is a block diagram of components of a mobile device 900 operable to perform passive beacon communication techniques according to various embodiments. Mobile device 900 includes antennas for at least two different wireless protocols, as described above. The first wireless protocol (e.g., Bluetooth) may be used for authentication and exchanging ranging settings. The second wireless protocol (e.g., UWB) may be used for performing ranging with another mobile device.

As shown, mobile device 900 includes UWB antennas 910 for performing ranging. UWB antennas 910 are connected to UWB circuitry 915 for analyzing detected signals from UWB antennas 910. In some embodiments, mobile device 900 includes three or more UWB antennas, e.g., for performing triangulation. The different UWB antennas can have different orientations, e.g., two in one direction and a third in another direction. The orientations of the UWB antennas can define a field of view for ranging. As an example, the field of view can span 10 degrees. Such regulation can allow a determination of which direction a user is pointing a device relative to one or more other nearby devices. The field of view may include any one or more of pitch, yaw, or roll angles.

UWB circuitry 915 can communicate with an always-on processor (AOP) 930, which can perform further processing using information from UWB messages. For example, AOP 930 can perform the ranging calculations using timing data provided by UWB circuitry 915. AOP 930 and other circuits of the device can include dedicated circuitry and/or configurable circuitry, e.g., via firmware or other software.

As shown, mobile device 900 also includes Bluetooth (BT)/Wi-Fi antenna 920 for communicating data with other devices. Bluetooth (BT)/Wi-Fi antenna 920 is connected to BT/Wi-Fi circuitry 925 for analyzing detected signals from BT/Wi-Fi antenna 920. For example, BT/Wi-Fi circuitry 925 can parse messages to obtain data (e.g., an authentication tag), which can be sent on to AOP 930. In some embodiments, AOP 930 can perform authentication using an authentication tag. Thus, AOP 930 can store or retrieve a list of authentication tags for which to compare a received tag against, as part of an authentication process. In some implementations, such functionality could be achieved by BT/Wi-Fi circuitry 925.

In other embodiments, UWB circuitry 915 and BT/Wi-Fi circuitry 925 can alternatively or in addition be connected to application processor 940, which can perform similar functionality as AOP 930. Application processor 940 typically requires more power than AOP 930, and thus power can be saved by AOP 930 handling certain functionality, so that application processor 940 can remain in a sleep state, e.g., an off state. As an example, application processor 940 can be used for communicating audio or video using BT/Wi-Fi, while AOP 930 can coordinate transmission of such content and communication between UWB circuitry 915 and BT/Wi-Fi circuitry 925. For instance, AOP 930 can coordinate timing of UWB messages relative to BT advertisements.

Coordination by AOP 930 can have various benefits. For example, a first user of a sending device may want to share content with another user, and thus ranging may be desired with a receiving device of this other user. However, if many people are in the same room, the sending device may need to distinguish a particular device among the multiple devices in the room, and potentially determine which device the sending device is pointing to. Such functionality can be provided by AOP 930. In addition, it is not desirable to wake up the application processor of every other device in the room, and thus the AOPs of the other devices can perform some processing of the messages and determine that the destination address is for a different device.

To perform ranging, BT/Wi-Fi circuitry 925 can analyze an advertisement signal from another device to determine that the other device wants to perform ranging, e.g., as part of a process for sharing content. BT/Wi-Fi circuitry 925 can communicate this notification to AOP 930, which can schedule UWB circuitry 915 to be ready to detect UWB messages from the other device.

For the device initiating ranging, its AOP can perform the ranging calculations. Further, the AOP can monitor changes in distance between the other devices. For example, AOP 930 can compare the distance to a threshold value and provide an alert when the distance exceeds a threshold, or potentially provide a reminder when the two devices become sufficiently close. An example of the former might be when a parent wants to be alerted when a child (and presumably the child's device) is too far away. An example of the latter might be when a person wants to be reminded to bring up something when talking to a user of the other device. Such monitoring by the AOP can reduce power consumption by the application processor.

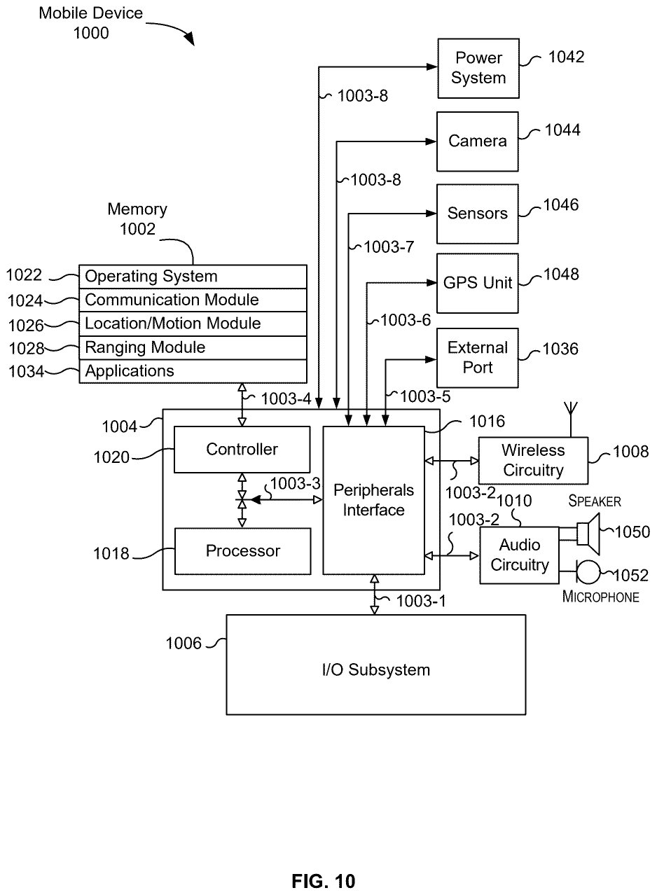

FIG. 10 is a block diagram of an example mobile device 1000 according to various embodiments. The mobile device 1000 can include a smartphone, a wearable device (e.g., a smartwatch, smart glasses), a tablet computer, a laptop computer, or a desktop computer. The mobile device 1000 generally includes computer-readable medium 1002, control circuitry 1004, an Input/Output (I/O) subsystem 1006, wireless circuitry 1008, and audio circuitry 1010 including speaker 1050 and microphone 1052. These components may be coupled by one or more communication buses or signal lines 1003. Mobile device 1000 can be any portable electronic device, including a handheld computer, a tablet computer, a mobile phone, a laptop computer, a tablet device, a media player, a personal digital assistant (PDA), a key fob, a car key, an access card, a multifunction device, a mobile phone, a portable gaming device, a headset, or the like, including a combination of two or more of these items.

It should be apparent that the architecture shown in FIG. 10 is only one example of an architecture for mobile device 1000, and that mobile device 1000 can have more or fewer components than shown, or a different configuration of components. The various components shown in FIG. 10 can be implemented in hardware, software, or a combination of both hardware and software, including one or more signal processing and/or application-specific integrated circuits.

Wireless circuitry 1008 is used to send and receive information over a wireless link or network to one or more other devices' conventional circuitry such as an antenna system, a radio frequency (RF) transceiver, one or more amplifiers, a tuner, one or more oscillators, a digital signal processor, a CODEC chipset, memory, etc. Wireless circuitry 1008 can use various protocols, e.g., as described herein. In various embodiments, wireless circuitry 1008 is capable of establishing and maintaining communications with other devices using one or more communication protocols, including time division multiple access (TDMA), code division multiple access (CDMA), global system for mobile communications (GSM), Enhanced Data GSM Environment (EDGE), wideband code division multiple access (W-CDMA), Long Term Evolution (LTE), Long-term Evolution (LTE)-Advanced, Wi-Fi (such as Institute of Electrical and Electronics Engineers (IEEE) 802.11a, IEEE 802.11b, IEEE 802.11g and/or IEEE 802.11n), Bluetooth, Wi-MAX, voice over Internet Protocol (VOIP), near field communication protocol (NFC), a protocol for email, instant messaging, and/or a short message service (SMS), or any other suitable communication protocol, including communication protocols not yet developed as of the filing date of this document.

Wireless circuitry 1008 is coupled to control circuitry 1004 via peripherals interface 1016. Peripherals interface 1016 can include conventional components for establishing and maintaining communication between peripherals. Voice and data information received by wireless circuitry 1008 (e.g., in speech recognition or voice command applications) is sent to one or more processors 1018 via peripherals interface 1016. One or more processors 1018 are configurable to process various data formats for one or more application programs 1034 stored on computer-readable medium 1002.

Peripherals interface 1016 couple the input and output peripherals of mobile device 1000 to the one or more processors 1018 and computer-readable medium 1002. One or more processors 1018 communicate with computer-readable medium 1002 via a controller 1020. Computer-readable medium 1002 can be any device or medium that can store code and/or data for use by one or more processors 1018. Computer-readable medium 1002 can include a memory hierarchy, including cache, main memory, and secondary memory. The memory hierarchy can be implemented using any combination of RAM (e.g., Standard Random Access Memory (SRAM), Dynamic Random Access Memory (DRAM), Double Data Random Access Memory (DDRAM), Read Only Memory (ROM), FLASH, magnetic and/or optical storage devices, such as disk drives, magnetic tape, CDs (compact disks) and DVDs (digital video discs). In some embodiments, peripherals interface 1016, one or more processors 1018, and controller 1020 can be implemented on a single chip, such as control circuitry 1004. In some other embodiments, they can be implemented on separate chips.

Processors 1018 can include hardware and/or software elements that perform one or more processing functions, such as mathematical operations, logical operations, data manipulation operations, data transfer operations, controlling the reception of user input, controlling output of information to users, or the like. Processors 1018 can be embodied as one or more hardware processors, microprocessors, microcontrollers; field programmable gate arrays (FPGAs), application-specified integrated circuits (ASICs), or the like.

Mobile device 1000 may include storage and processing circuitry such as control circuitry 1004. Control circuitry 1004 may include storage such as hard disk drive storage, nonvolatile memory (e.g., flash memory or other electrically-programmable-read-only memory configured to form a solid-state drive), volatile memory (e.g., static or dynamic random-access-memory), etc. Processing circuitry in control circuitry 1004 may be used to control the operation of mobile device 1000. This processing circuitry may be based on one or more microprocessors, microcontrollers, digital signal processors, baseband processor integrated circuits, application specific integrated circuits, etc.

Control circuitry 1004 may be used to run software on mobile device 1000, such as internet browsing applications, voice-over-internet-protocol (VOIP) telephone call applications, email applications, media playback applications, operating system functions, etc. To support interactions with external equipment, control circuitry 1004 may be used in implementing communications protocols. Communications protocols that may be implemented using control circuitry 1004 include internet protocols, wireless local area network protocols (e.g., IEEE 802.11 protocols-sometimes referred to as Wi-Fi®), protocols for other short-range wireless communications links such as the Bluetooth® protocol, cellular telephone protocols, multiple-input and multiple-output (MIMO) protocols, antenna diversity protocols, satellite navigation system protocols, millimeter wave communications protocols, IEEE 802.15.4 ultra-wideband communications protocols, etc.

Mobile device 1000 may include I/O subsystems 1006. I/O subsystems 1006 may include input-output devices. Input-output devices may be used to allow data to be supplied to mobile device 1000 and to allow data to be provided from mobile device 1000 to external devices. Input-output devices may include user interface devices, data port devices, and other input-output components. For example, input-output devices may include one or more displays (e.g., touch screens or displays without touch sensor capabilities), one or more image sensors 1044 (e.g., digital image sensors), motion sensors, and speakers 1050. Input-output devices may also include buttons, joysticks, scrolling wheels, touch pads, key pads, keyboards, microphones 1052, haptic elements such as vibrators and actuators, status indicators, light sources, audio jacks and other audio port components, digital data port devices, light sensors, capacitance sensors, proximity sensors (e.g., a capacitive proximity sensor and/or an infrared proximity sensor), magnetic sensors, and other sensors and input-output components.

Mobile device 1000 also includes a power system 1042 for powering the various hardware components. Power system 1042 can include a power management system, one or more power sources (e.g., battery, alternating current (AC)), a recharging system, a power failure detection circuit, a power converter or inverter, a power status indicator (e.g., a light emitting diode (LED)) and any other components typically associated with the generation, management and distribution of power in mobile devices.

In some embodiments, mobile device 1000 includes an image sensor 1044 (e.g., a camera). In some embodiments, mobile device 1000 includes sensors 1046. Sensors can include accelerometers, compass, gyrometer, pressure sensors, audio sensors, light sensors, barometers, and the like. Sensors 1046 can be used to sense location aspects, such as auditory or light signatures of a location.

In some embodiments, mobile device 1000 can include a GPS receiver, sometimes referred to as a GPS unit 1048. A mobile device can use a satellite navigation system, such as the Global Positioning System (GPS), to obtain position information, timing information, altitude, or other navigation information. During operation, the GPS unit can receive signals from GPS satellites orbiting the Earth. The GPS unit analyzes the signals to make a transit time and distance estimation. The GPS unit can determine the current position (current location) of the mobile device. Based on these estimations, the mobile device can determine a location fix, altitude, and/or current speed. A location fix can be geographical coordinates such as latitudinal and longitudinal information.

One or more processors 1018 run various software components stored in computer-readable medium 1002 to perform various functions for mobile device 1000. In some embodiments, the software components include an operating system 1022, a communication module 1024 (or set of instructions), a location/motion module 1026 (or set of instructions), a ranging module 1028 that is used as part of ranging operation described herein, and other application programs 1034 (or set of instructions).

Operating system 1022 can be any suitable operating system, including iOS, Mac OS, Darwin, Quatros Real-Time Operating System (RTXC), LINUX, UNIX, OS X, WINDOWS, or an embedded operating system such as VxWorks. The operating system can include various procedures, sets of instructions, software components, and/or drivers for controlling and managing general system tasks (e.g., memory management, storage device control, power management, etc.) and facilitates communication between various hardware and software components.

Communication module 1024 facilitates communication with other devices over one or more external ports 1036 or via wireless circuitry 1008 and includes various software components for handling data received from wireless circuitry 1008 and/or external port 1036. Communication module 1024 can be used to exchange proximity messages with one or more electronic devices. External port 1036 (e.g., universal serial bus (USB), FireWire, Lightning connector, 80-pin connector, etc.) is adapted for coupling directly to other devices or indirectly over a network (e.g., the Internet, wireless LAN, etc.).

Location/motion module 1026 can assist in determining the current position (e.g., coordinates or other geographic location identifiers) and motion of mobile device 1000. Modern positioning systems include satellite based positioning systems, such as Global Positioning System (GPS), cellular network positioning based on “cell IDs,” and Wi-Fi positioning technology based on a Wi-Fi networks. GPS also relies on the visibility of multiple satellites to determine a position estimate, which may not be visible (or have weak signals) indoors or in “urban canyons.” In some embodiments, location/motion module 1026 receives data from GPS unit 1048 and analyzes the signals to determine the current position of the mobile device. In some embodiments, location/motion module 1026 can determine a current location using Wi-Fi or cellular location technology. For example, the location of the mobile device can be estimated using knowledge of nearby cell sites and/or Wi-Fi access points with knowledge also of their locations. Information identifying the Wi-Fi or cellular transmitter is received at wireless circuitry 1008 and is passed to location/motion module 1026. In some embodiments, the location module receives the one or more transmitter IDs. In some embodiments, a sequence of transmitter IDs can be compared with a reference database (e.g., Cell ID database, Wi-Fi reference database) that maps or correlates the transmitter IDs to position coordinates of corresponding transmitters, and computes estimated position coordinates for mobile device 1000 based on the position coordinates of the corresponding transmitters. Regardless of the specific location technology used, location/motion module 1026 receives information from which a location fix can be derived, interprets that information, and returns location information, such as geographic coordinates, latitude/longitude, or other location fix data,

Ranging module 1028 can send/receive ranging messages to/from an antenna, e.g., connected to wireless circuitry 1008. The messages can be used for various purposes, e.g., to identify a sending antenna of a device, determine timestamps of messages to determine a distance of mobile device 1000 from another device. Ranging module 1028 can exist on various processors of the device, e.g., an always-on processor (AOP), a UWB chip, and/or an application processor. For example, parts of ranging module 1028 can determine a distance on an AOP, and another part of the ranging module can interact with a sharing module, e.g., to display a position of the other device on a screen in order for a user to select the other device to share a data item. Ranging module 1028 can also interact with a reminder module that can provide an alert based on a distance from another mobile device.

Dielectric-filled openings such as plastic-filled openings may be formed in metal portions of housing such as in metal sidewall structures (e.g., to serve as antenna windows and/or to serve as gaps that separate portions of antennas from each other).

Antennas may be mounted in housing. If desired, some of the antennas (e.g., antenna arrays that may implement beam steering, etc.) may be mounted under dielectric portions of mobile device 1000 (e.g., portions of the display cover layer, portions of a plastic antenna window in a metal housing sidewall portion of housing, etc.). With one illustrative configuration, some or all of the rear face of mobile device 1000 may be formed from a dielectric. For example, the rear wall of housing may be formed from glass plastic, ceramic, other dielectric. In this type of arrangement, antennas may be mounted within the interior of mobile device 1000 in a location that allows the antennas to transmit and receive antenna signals through the rear wall of mobile device 1000 (and, if desired, through optional dielectric sidewall portions in housing). Antennas may also be formed from metal sidewall structures in housing and may be located in peripheral portions of mobile device 1000.

To avoid disrupting communications when an external object such as a human hand or other body part of a user blocks one or more antennas, antennas may be mounted at multiple locations in housing. Sensor data such as proximity sensor data, real-time antenna impedance measurements, signal quality measurements such as received signal strength information, and other data may be used in determining when one or more antennas are being adversely affected due to the orientation of housing, blockage by a user's hand or other external object, or other environmental factors. Mobile device 1000 can then switch one or more replacement antennas into use in place of the antennas that are being adversely affected.

Antennas may be mounted at the corners of housing, along the peripheral edges of housing, on the rear of housing, under the display cover layer that is used in covering and protecting display on the front of mobile device 1000 (e.g., a glass cover layer, a sapphire cover layer, a plastic cover layer, other dielectric cover layer structures, etc.), under a dielectric window on a rear face of housing or the edge of housing, under a dielectric rear wall of housing, or elsewhere in mobile device 1000. As an example, antennas may be mounted at one or both ends of mobile device 1000 (e.g., along the upper and lower edges of housing, at the corners of housing, etc.).

Antennas in mobile device 1000 may include cellular telephone antennas, wireless local area network antennas (e.g., Wi-Fi® antennas at 3.4 GHz and 7 GHZ and other suitable wireless local area network antennas), satellite navigation system signals, and near-field communications antennas. The antennas may also include antennas that support IEEE 1002.15.4 ultra-wideband communications protocols and/or antennas for handling millimeter wave communications. For example, the antennas may include two or more ultra-wideband frequency antennas and/or millimeter wave phased antenna arrays. Millimeter wave communications, which are sometimes referred to as extremely high frequency (EHF) communications, involve signals at 80 GHz or other frequencies between about 10 GHz and 600 GHz.

Wireless circuitry in mobile device 1000 may support communications using the IEEE 802.15.4 ultra-wideband protocol. In an IEEE 802.15.4 system, a pair of devices may exchange wireless time stamped messages. Time stamps in the messages may be analyzed to determine the time of flight of the messages and thereby determine the distance (range) between the devices.

Image sensors 1044 may include one or more visible digital image sensors (visible-light cameras) and/or one or more infrared digital image sensors (infrared-light cameras). Image sensors 1044 may, if desired, be used to measure distances. For example, an infrared time-of-flight image sensor may be used to measure the time that it takes for an infrared light pulse to reflect back from objects in the vicinity of mobile device 1000, which may in turn be used to determine the distance to those objects. Visible imaging systems such as a front and/or rear-facing camera in mobile device 1000 may also be used to determine the position of objects in the environment. For example, control circuitry 1004 may use image sensors 1044 to perform simultaneous localization and mapping (SLAM). SLAM refers to the process of using images to determine the position of objects in the environment while also constructing a representation of the imaged environment. Visual SLAM techniques include detecting and tracking certain features in images such as edges, textures, room corners, window corners, door corners, faces, sidewalk edges, street edges, building edges, tree trunks, and other prominent features. Control circuitry 1004 may rely entirely upon image sensors 1044 to perform simultaneous localization and mapping, or control circuitry 1004 may synthesize image data with range data from one or more distance sensors (e.g., light-based proximity sensors). If desired, control circuitry 1004 may use a display to display a visual representation of the mapped environment.

Input-output devices may include motion sensor circuitry 1046. Motion sensor circuitry 1046 may include one or more accelerometers (e.g., accelerometers that measure acceleration along one, two, or three axes), gyroscopes, barometers, magnetic sensors (e.g., compasses), image sensors (e.g., image sensor 1044) and other sensor structures. Sensors 1046 may, for example, include one or more microelectromechanical systems (MEMS) sensors (e.g., accelerometers, gyroscopes, microphones, force sensors, pressure sensors, capacitive sensors, or any other suitable type of sensor formed using microelectromechanical systems technology).

Control circuitry 1004 may be used to store and process motion sensor data. If desired, motion sensors, processing circuitry, and storage that form motion sensor circuitry may form part of a system-on-chip integrated circuit (as an example).

Input-output devices may include movement generation circuitry. Movement generation circuitry may receive control signals from control circuitry 1004. Movement generation circuitry may include electromechanical actuator circuitry that, when driven, moves mobile device 1000 in one or more directions. For example, movement generation circuitry may laterally move mobile device 1000 and/or may rotate mobile device 1000 around one or more axes of rotation. Movement generation circuitry may, for example, include one or more actuators formed at one or more locations of mobile device 1000. When driven by a motion control signal, actuators may move (e.g., vibrate, pulse, tilt, push, pull, rotate, etc.) to cause mobile device 1000 to move or rotate in one or more directions. The movement may be slight (e.g., not noticeable or barely noticeable to a user of mobile device 1000), or the movement may be substantial. Actuators may be based on one or more vibrators, motors, solenoids, piezoelectric actuators, speaker coils, or any other desired device capable of mechanically (physically) moving mobile device 1000.

Some or all of movement generation circuitry such as actuators may be used to perform operations that are unrelated to rotation of mobile device 1000. For example, actuators may include vibrators that are actuated to issue a haptic alert or notification to a user of mobile device 1000. Such alerts may include, for example, a received text message alert identifying that mobile device 1000 has received a text message, a received telephone call alert, a received email alert, an alarm notification alert, a calendar notification alert, or any other desired notification. By actuating actuator, mobile device 1000 may inform the user of any desired device condition.

Motion sensor circuitry may sense motion of mobile device 1000 that is generated by movement generation circuitry. If desired, motion sensor circuitry may provide feedback signals associated with the sensed motion of mobile device 1000 to movement generation circuitry. Movement generation circuitry may use the feedback signals to control actuation of the movement generation circuitry.

Control circuitry 1004 may use motion sensor circuitry and/or movement generation circuitry to determine the angle of arrival of wireless signals received by mobile device 1000 from another electronic device. For example, control circuitry 1004 may use movement generation circuitry to move mobile device 1000 from one position to another. Motion sensor circuitry may be used to track the movement of mobile device 1000 as it is moved between the different positions. At each position, control circuitry 1004 may receive wireless signals from another electronic device. Control circuitry 1004 may process the received wireless signals together with the motion data from motion sensor circuitry to more accurately determine the position of the other electronic device. The use of motion generation circuitry is merely illustrative, however. If desired, motion sensor circuitry may track movement of mobile device 1000 that is not caused by motion generation circuitry. This may include a user's natural, unprompted movement of mobile device 1000 and/or the user's movement of mobile device 1000 after the user is prompted (by display, audio circuitry 1010, a haptic output device in mobile device 1000, or any other suitable output device) to move mobile device 1000 in a particular fashion.

Other sensors that may be included in input-output devices include ambient light sensors for gathering information on ambient light levels, proximity sensor components (e.g., light-based proximity sensors, capacitive proximity sensors, and/or proximity sensors based on other structures), depth sensors (e.g., structured light depth sensors that emit beams of light in a grid, a random dot array, or other pattern, and that have image sensors that generate depth maps based on the resulting spots of light produced on target objects), sensors that gather three-dimensional depth information using a pair of stereoscopic image sensors, LIDAR (light detection and ranging) sensors, radar sensors, and other suitable sensors.

Input-output circuitry may include wireless communications circuitry for communicating wirelessly with external equipment. Wireless communications circuitry may include radio frequency (RF) transceiver circuitry formed from one or more integrated circuits, power amplifier circuitry, low-noise input amplifiers, passive RF components, one or more antennas, transmission lines, and other circuitry for handling RF wireless signals. Wireless signals can also be sent using light (e.g., using infrared communications).

Wireless circuitry 1008 may include radio-frequency transceiver circuitry for handling various radio-frequency communications bands. For example, wireless circuitry 1008 may include transceiver circuitry.

Transceiver circuitry may be wireless local area network transceiver circuitry. Transceiver circuitry may handle 2.4 GHz and 5 GHz bands for Wi-Fi® (IEEE 802.11) communications and may handle the 2.4 GHz Bluetooth® communications band.

Circuitry may use cellular telephone transceiver circuitry for handling wireless communications in frequency ranges such as a communications band from 700 to 960 MHz, a band from 1710 to 2170 MHz, a band from 2300 to 2700 MHz, other bands between 700 and 2700 MHz, higher bands such as LTE bands 42 and 43 (3.4-3.6 GHz), or other cellular telephone communications bands. Circuitry may handle voice data and non-voice data.

Millimeter wave transceiver circuitry (sometimes referred to as extremely high frequency transceiver circuitry) may support communications at extremely high frequencies (e.g., millimeter wave frequencies such as extremely high frequencies of 10 GHz to 400 GHz or other millimeter wave frequencies). For example, circuitry may support IEEE 802.11ad communications at 60 GHz. Circuitry may be formed from one or more integrated circuits (e.g., multiple integrated circuits mounted on a common printed circuit in a system-in-package device, one or more integrated circuits mounted on different substrates, etc.).

Ultra-wideband transceiver circuitry may support communications using the IEEE 802.15.4 protocol and/or other wireless communications protocols. Ultra-wideband wireless signals may be characterized by bandwidths greater than 500 MHz or bandwidths exceeding 20% of the center frequency of radiation. The presence of lower frequencies in the baseband may allow ultra-wideband signals to penetrate through objects such as walls. Transceiver circuitry may operate in a 2.4 GHz frequency band, a 6.5 GHz frequency band, an 8 GHz frequency band, and/or at other suitable frequencies.

Wireless communications circuitry may include satellite navigation system circuitry such as Global Positioning System (GPS) receiver circuitry for receiving GPS signals at 1575 MHz or for handling other satellite positioning data (e.g., GLONASS signals at 1609 MHz). Satellite navigation system signals for a receiver are received from a constellation of satellites orbiting the earth.

In satellite navigation system links, cellular telephone links, and other long-range links, wireless signals are typically used to convey data over thousands of feet or miles. In Wi-Fi® and Bluetooth® links at 2.4 and 5 GHz and other short-range wireless links, wireless signals are typically used to convey data over tens or hundreds of feet. Extremely high frequency (EHF) wireless transceiver circuitry may convey signals over these short distances that travel between transmitter and receiver over a line-of-sight path. To enhance signal reception for millimeter wave communications, phased antenna arrays and beam steering techniques may be used (e.g., schemes in which antenna signal phase and/or magnitude for each antenna in an array is adjusted to perform beam steering). Antenna diversity schemes may also be used to ensure that the antennas that have become blocked or that are otherwise degraded due to the operating environment of mobile device 1000 can be switched out of use and higher-performing antennas used in their place.

Wireless communications circuitry can include circuitry for other short-range and long-range wireless links if desired. For example, wireless communications circuitry 46 may include circuitry for receiving television and radio signals, paging system transceivers, near field communications (NFC) circuitry, etc.

The one or more applications 1034 on mobile device 1000 can include any applications installed on the mobile device 1000, including without limitation, a browser, address book, contact list, email, instant messaging, social networking, word processing, keyboard emulation, widgets, JAVA-enabled applications, encryption, digital rights management, voice recognition, voice replication, a music player (which plays back recorded music stored in one or more files, such as MP3 or advanced audio codec (AAC) files), etc.

There may be other modules or sets of instructions (not shown), such as a graphics module, a time module, etc. For example, the graphics module can include various conventional software components for rendering, animating and displaying graphical objects (including without limitation text, web pages, icons, digital images, animations, and the like) on a display surface. In another example, a timer module can be a software timer. The timer module can also be implemented in hardware. The time module can maintain various timers for any number of events.

I/O subsystem 1006 can be coupled to a display system (not shown), which can be a touch-sensitive display. The display displays visual output to the user in a GUI. The visual output can include text, graphics, video, and any combination thereof. Some or all of the visual output can correspond to user-interface objects. A display can use LED (light emitting diode) technology, LCD (liquid crystal display) technology, or LPD (light emitting polymer display) technology, although other display technologies can be used in other embodiments.

In some embodiments, I/O subsystem 1006 can include a display and user input devices such as a keyboard, mouse, and/or trackpad. In some embodiments, I/O subsystem 1006 can include a touch-sensitive display. A touch-sensitive display can also accept input from the user based at least part on haptic and/or tactile contact. In some embodiments, a touch-sensitive display forms a touch-sensitive surface that accepts user input. The touch-sensitive display/surface (along with any associated modules and/or sets of instructions in computer-readable medium 1002) detects contact (and any movement or release of the contact) on the touch-sensitive display and converts the detected contact into interaction with user-interface objects, such as one or more soft keys, that are displayed on the touch screen when the contact occurs. In some embodiments, a point of contact between the touch-sensitive display and the user corresponds to one or more digits of the user. The user can make contact with the touch-sensitive display using any suitable object or appendage, such as a stylus, pen, finger, and so forth. A touch-sensitive display surface can detect contact and any movement or release thereof using any suitable touch sensitivity technologies, including capacitive, resistive, infrared, and surface acoustic wave technologies, as well as other proximity sensor arrays or other elements for determining one or more points of contact with the touch-sensitive display.

Further, I/O subsystem 1006 can be coupled to one or more other physical control devices (not shown), such as pushbuttons, keys, switches, rocker buttons, dials, slider switches, sticks, LEDs, etc., for controlling or performing various functions, such as power control, speaker volume control, ring tone loudness, keyboard input, scrolling, hold, menu, screen lock, clearing and ending communications and the like. In some embodiments, in addition to the touch screen, mobile device 1000 can include a touchpad (not shown) for activating or deactivating particular functions. In some embodiments, the touchpad is a touch-sensitive area of the mobile device 1000 that, unlike the touch screen, does not display visual output. The touchpad can be a touch-sensitive surface that is separate from the touch-sensitive display or an extension of the touch-sensitive surface formed by the touch-sensitive display.

In some embodiments, some or all of the operations described herein can be performed using an application executing on the user's device. Circuits, logic modules, processors, and/or other components may be configured to perform various operations described herein. Those skilled in the art will appreciate that, depending on implementation, such configuration can be accomplished through design, setup, interconnection, and/or programming of the particular components and that, again depending on implementation, a configured component might or might not be reconfigurable for a different operation. For example, a programmable processor can be configured by providing suitable executable code; a dedicated logic circuit can be configured by suitably connecting logic gates and other circuit elements; and so on.

Any of the software components or functions described in this application may be implemented as software code to be executed by a processor using any suitable computer language such as, for example, Java, C, C++, C #, Objective-C, Swift, or scripting language such as Perl or Python using, for example, conventional or object-oriented techniques. The software code may be stored as a series of instructions or commands on a computer readable medium for storage and/or transmission. A suitable non-transitory computer readable medium can include random access memory (RAM), a read only memory (ROM), a magnetic medium such as a hard-drive or a floppy disk, or an optical medium, such as a compact disk (CD) or DVD (digital versatile disk), flash memory, and the like. The computer readable medium may be any combination of such storage or transmission devices.

Computer programs incorporating various features of the present disclosure may be encoded on various computer readable storage media; suitable media include magnetic disk or tape, optical storage media, such as compact disk (CD) or DVD (digital versatile disk), flash memory, and the like. Computer readable storage media encoded with the program code may be packaged with a compatible device or provided separately from other devices. In addition, program code may be encoded and transmitted via wired optical, and/or wireless networks conforming to a variety of protocols, including the Internet, thereby allowing distribution, e.g., via Internet download. Any such computer readable medium may reside on or within a single computer product (e.g., a solid state drive, a hard drive, a CD, or an entire computer system), and may be present on or within different computer products within a system or network. A computer system may include a monitor, printer, or other suitable display for providing any of the results mentioned herein to a user.

As described above, one aspect of the present technology is the gathering, sharing, and use of data, including the location of various electronic devices. The present disclosure contemplates that, in some instances, this gathered data may include personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to locate lost personal property and companion animals. Further, other uses for personal information data that benefit the user are also contemplated by the present disclosure.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence, different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of sharing content and performing ranging, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, users may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data at a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

Although the present disclosure has been described with respect to specific embodiments, it will be appreciated that the disclosure is intended to cover all modifications and equivalents within the scope of the following claims.

All patents, patent applications, publications, and descriptions mentioned herein are incorporated by reference in their entirety for all purposes. None is admitted to be prior art.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. The phrase “based on” should be understood to be open-ended, and not limiting in any way, and is intended to be interpreted or otherwise read as “based at least in part on,” where appropriate. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure. The use of “or” is intended to mean an “inclusive or,” and not an “exclusive or,” unless specifically indicated to the contrary. Reference to a “first” component does not necessarily require that a second component be provided. Moreover, reference to a “first” or a “second” component does not limit the referenced component to a particular location unless expressly stated. The term “based on” is intended to mean “based at least in part on.”

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z).

Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”

Preferred embodiments of this disclosure are described herein, including the best mode known to the inventors for carrying out the disclosure. Variations of those preferred embodiments may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

1. A method comprising:
receiving, by an electronic user device, a network location identifier associated with a portable device;
accessing, by the electronic user device and using the network location identifier, a tracking identifier for the portable device; and
initiating, by the electronic user device, a local finding operation with the portable device by:
identifying, by the electronic user device, the portable device by matching at least a portion of the tracking identifier to an advertising message that is received at the electronic user device from the portable device;
establishing, by the electronic user device, a communication link with the portable device; and
communicating, by the electronic user device and via the communication link, with the portable device to perform the local finding operation.

2. The method of claim 1, wherein the portion of the tracking identifier comprises a last six digits of a public key of the portable device.

3. The method of claim 1, wherein the local finding operation comprises:
instructing the portable device to emit a sound.

4. The method of claim 1, wherein the local finding operation comprises:
obtaining, by the electronic user device, location information for the portable device; and
displaying, by the electronic user device, a graphical user interface that includes the location information on a display of the electronic user device.

5. The method of claim 1, wherein the local finding operation comprises:
determining, by the electronic user device, a relative position of the portable device based on the communication, wherein the relative position comprises one or more of a distance and a direction of the portable device relative to the electronic user device; and
displaying, by the electronic user device, the relative position of the portable device on a display of the electronic user device.

6. The method of claim 1, wherein the advertising message is one of a plurality of identical advertising messages that were received at the electronic user device over a time period.

7. The method of claim 6, wherein the time period is greater than fifteen minutes.

1-19. (canceled)

20. An electronic user device, comprising:
one or more processors;
a memory storing instructions that, when executed by the one or more processors, cause the electronic user device to
receive a network location identifier associated with a portable device;
access, using the network location identifier, a tracking identifier for the portable device; and
initiate a local finding operation with the portable device by:
identifying the portable device by matching at least a portion of the tracking identifier to an advertising message that is received at the electronic user device from the portable device;
establishing a communication link with the portable device; and
communicating, via the communication link, with the portable device to perform the local finding operation.

21. The electronic user device of claim 20, wherein the portion of the tracking identifier comprises a last six digits of a public key of the portable device.

22. The electronic user device of claim 20, wherein the local finding operation comprises:
instructing the portable device to emit a sound.

23. The electronic user device of claim 20, wherein the local finding operation comprises:
obtaining location information for the portable device; and
displaying a graphical user interface that includes the location information on a display of the electronic user device.

24. The electronic user device of claim 20, wherein the local finding operation comprises:
determining a relative position of the portable device based on the communication, wherein the relative position comprises one or more of a distance and a direction of the portable device relative to the electronic user device; and
displaying the relative position of the portable device on a display of the electronic user device.

25. The electronic user device of claim 20, wherein the advertising message is one of a plurality of identical advertising messages that were received at the electronic user device over a time period.

26. The electronic user device of claim 25, wherein the time period is greater than fifteen minutes.

27. A non-transitory, computer readable medium storing instructions that when executed on one or more processors of electronic user device cause the electronic user device to:
receive a network location identifier associated with a portable device;
access, using the network location identifier, a tracking identifier for the portable device; and
initiate a local finding operation with the portable device by:
identifying the portable device by matching at least a portion of the tracking identifier to an advertising message that is received at the electronic user device from the portable device;
establishing a communication link with the portable device; and
communicating, via the communication link, with the portable device to perform the local finding operation.

28. The non-transitory, computer readable medium of claim 27, wherein the portion of the tracking identifier comprises a last six digits of a public key of the portable device.

29. The non-transitory, computer readable medium of claim 27, wherein the local finding operation comprises:
instructing the portable device to emit a sound.

30. The non-transitory, computer readable medium of claim 27, wherein the local finding operation comprises:
obtaining location information for the portable device; and
displaying a graphical user interface that includes the location information on a display of the electronic user device.

31. The non-transitory, computer readable medium of claim 27, wherein the local finding operation comprises:
determining a relative position of the portable device based on the communication, wherein the relative position comprises one or more of a distance and a direction of the portable device relative to the electronic user device; and
displaying the relative position of the portable device on a display of the electronic user device.

32. The non-transitory, computer readable medium of claim 27, wherein the advertising message is one of a plurality of identical advertising messages that were received at the electronic user device over a time period.
